(19) United States
(12) Patent Application Publication
(10) Pub. No.: US 2012/0179833 A1
(43) Pub. Date: Jul. 12, 2012

(54) METHOD AND APPARATUS FOR ADAPTING MEDIA

(75) Inventors: BRODY KENRICK, Erskineville (AU); WEI ZHOU, Petaluma, CA (US); DAVID JACK, Fairford (GB); MARWAN JABRI, Tiburon, CA (US)

(73) Assignee: ONMOBILE GLOBAL LIMITED, Bangalore (IN)

(21) Appl. No.: 13/150,400

(22) Filed: Jun. 1, 2011

Related U.S. Application Data
(60) Provisional application No. 61/350,883, filed on Jun. 2, 2010.

(51) Int. Cl. G06F 15/16

(52) U.S. Cl. 709/231

(57) ABSTRACT

A method and apparatus for adapting media is provided. The method includes receiving a request for a first media stream and a second media stream at different media times. The method further includes processing a source media stream to produce a first portion media stream and a second portion media stream using a media processing element. A method for processing media comprises creating a first media processing element and a second media processing element. The method further includes processing a first media stream using the first media processing element to produce assistance information. Further, the method includes processing a second media stream using the second media processing element wherein the second media processing element utilizes the assistance information.

### FIELD OF INVENTION

The present invention relates generally to the field of telecommunications and more specifically to a method and apparatus for efficient adaptation of multimedia content in a variety of telecommunications networks. More particularly, the present invention is directed towards adaptation and delivery of multimedia content in an efficient manner.

### BACKGROUND OF THE INVENTION

With the prevalence of communication networks and devices, multimedia content is widely used in the current industrial scenario. Multimedia content includes content such as, text, audio, video, still images, animation or a combination of the aforementioned content. Presently, businesses as well as individuals use multimedia content extensively for various purposes. A business organization may use it for providing services to customers or for internally using it as part of processes within the organization. Multimedia content in various formats is frequently recorded, displayed, played or transferred to customers through diverse communication networks and devices. In some cases multimedia content is accessed by customers in varied formats using a diverse range of terminals. Examples of diversity of multimedia content may include data conforming to diverse protocols such as Ethernet, 2G, 3G, 4G, General Packet Radio Service (GPRS), Universal Mobile Telecommunications System (UMTS), Enhanced Data Rates for GSM Evolution (EDGE), Long Term Evolution (LTE) etc. When multimedia content is pre-encoded for later use, this consumes significant amounts of memory for storage, bandwidth for exchange and creates complexity in the management of the encoded clips.

An example of numerous formats of media content in use includes media content related to mobile internet usage. Mobile internet usage is an increasingly popular market trend and about 25% of 3G users use 3G modems on their notebooks and netbooks to access the internet and video browsing is a part of this usage. The popularity of devices such as the iPhone and iPad is also having an impact as about 40% of iPhone users browse videos because of its wide screen feature and easy to use web browser. More devices are coming on the market with similar wide screens and Half-Size Video Graphics Array (HVGA) resolutions and devices with Video Graphics Array (VGA) and Wide VGA screens also becoming available (e.g. Samsung H1/Vodafone 360 H1 device with 800 by 480 pixel resolution).

An example of differing format of media content frequently desired is media content used by consumer electronic devices. Consumer video devices capable of recording High Definition (HD-720 or 1080 lines of pixels) videos are rapidly spreading in the market today. Not only cameras, but also simple to use devices such as the Pure Digital Flip HD camcorder. These devices provide an increasingly simple way to share videos. The price point of these devices and the simplicity of their use and the upload of videos to the web will have a severe impact on mobile network congestions. Internet video is increasingly HD, and mobile HD access devices are in the market to consume such content.

Further, multimedia streaming services, such as Internet Protocol Television (IPTV), Video on Demand (VoD), and internet radio/music, allow for various forms of multimedia content to be streamed to a diverse range of terminals in different networks. The streaming services are generally based on streaming technologies such as Real Time Streaming Protocol (RTSP), Hyper Text Transfer Protocol (HTTP) progressive download, Session Initiation Protocol (SIP), Extensible Messaging and Presence Protocol (XMPP), and variants of these standards (e.g. adapted or modified). Variants of the aforementioned protocols are referred to as HTTP-like, RTSP-like, SIP-like and XMPP-like, or a combination of these (e.g. OpenIPTV).

Provision of typical media services generally include streaming three types of content i.e. live, programmed, or on-demand. Programmed and on-demand content generally use pre-recorded media. With streaming technologies, live or pre-recorded media is sent in a continuous stream to the terminal which processes it and plays it (display video or pictures or play the audio and sounds) as it is received (typically within some relatively small buffering period). To achieve smooth playing of media and avoiding a backlog of data, the media bit rate should be equal to or less than data transfer rate of networks. Streaming media is usually compressed to bitrates which can meet network bandwidth requirements. As the transmission of the media is from a source (e.g. streaming server or terminal) to terminals, the media bit rate is limited by the bandwidth of the network uplink and/or downlink. Networks supporting multimedia streaming services are packet-switched networks, which include 2.5G, 3G/3.5G packet-switched cellular network, their 4G and 5G evolutions, wired and wireless LAN, broadband internet, etc. These networks have different downlink bandwidths because different access technologies are used. Further, the downlink bandwidth may vary depending on number of users sharing the bandwidth, or the quality of the downlink channel.

Nowadays, users located at geographically diverse locations expect real time delivery of media content. The difficulty of providing media content to diversely located users present significant problems for content deliverers. The type of content (long-tail, user generated, breaking news, on demand, live sports), differing device characteristics requiring different output type and different styles of content access present various challenges in providing media in the best form. Examples of different styles of content access include User-generated Content (UGC) with a single view after an upload, broken off sessions for news clips and UGC as the user skips to something more to their liking. Further, providing media in an efficient manner that avoids wastage is also challenging.

Thus, there is a need in the art for improved methods and systems for adapting and delivering multimedia content in various telecommunications networks.

### SUMMARY OF THE INVENTION

Embodiments of the present invention provide methods and apparatuses that deliver multimedia content. In particular it involves the delivery of adapted multimedia content, and further optimized multimedia content.

A method of processing media is provided. The method includes receiving a first request for a first stream of media and creating a media processing element. The method further includes processing a source media stream to produce a first portion media stream by using the media processing element. The method then determines that completion of the first request is at a particular media time N. The state of the media processing element is stored at a media time substantially equal to the media time N. The method of the invention then includes receiving a second request for a second media stream and determining that the second request reaches completion at an additional media time M as compared to media time N, wherein the media time M is greater than the media time N. The method further includes restoring the state of the media processing element to produce a restored media processing element with a media time R, which is substantially equal to the media time N. The method processes the source media stream using the media processing element to produce a second portion media stream comprising the media time M.

In various embodiments of the present invention, the method of processing media includes receiving a first request for a first media asset and creating a media processing element. The method then includes processing a source media stream to produce the first media asset by using the media processing element. It is then determined that the media processing element should not be destroyed. The method further includes receiving a second request for a second media asset and processing the source media stream using the media processing element to produce the second media asset.

In various embodiments of the present invention, the method of processing media includes receiving a first request for a first media asset and creating a media processing element. The method further includes processing a source media stream to produce the first media asset and a restore point by using the media processing element. The method further includes destroying the media processing element. The method then includes receiving a second request for a second media asset and recreating the media processing element by using the restore point. The method then includes processing the source media stream using the media processing element to produce the second media asset.

In various embodiments of the present invention, the method of processing media comprises receiving a first request for a media stream and creating a media processing element. The method includes processing a source media stream using the media processing element to produce a media stream and assistance information. The assistance information is then stored. The method further includes receiving a second request for the media stream. The source media stream is then reprocessed using a media reprocessing element to produce a refined media stream. The media processing element utilizes assistance information to produce the refined media stream.

In various embodiments of the present invention, the method of producing a seekable media stream includes receiving a first request for a media stream. The method then includes determining that the source media stream is non-seekable. The source media is then processed to produce seekability information. Thereafter, the method includes processing the source media stream and the seekability information to produce the seekable media stream.

In various embodiments of the present invention, a method of determining whether a media processing pipeline is seekable includes querying a first media processing element in the pipeline for a first seekability indication. The method then includes querying a second media processing element in the pipeline for a second seekability indication. The first seekability indication and the second seekability indication are then processed in order to determine if the pipeline is seekable.

An apparatus for processing media is provided. The apparatus comprises a media source element and a first media processing element coupled to the media source element. The apparatus further includes a first media caching element coupled to the first media processing element and a second media processing element coupled to the first media caching element. The apparatus further includes a second media caching element coupled to the second media processing element and a media output element coupled to the second media caching element.

In various embodiments of the present invention, the apparatus for processing media comprises a media source element, a first media processing element coupled to the media source element and a second media processing element coupled to the media output element. The apparatus further includes a first data bus coupled to the first media processing element and the second media processing element. The apparatus further includes a second data bus coupled to the first media processing element and the second media processing element.

In various embodiments of the present invention, the method of processing media comprises creating a first media processing element and a second media processing element. The method further includes processing a first media stream using the first media processing element to produce assistance information. A second media stream is then processed using the second media processing element. In an embodiment of the present invention, the assistance information produced by processing the first media stream is utilized by the second media processing element to process the second media stream.

An apparatus for encoding media is provided. The apparatus comprises a media input element, a first media output element and a second media output element. The apparatus further includes a common encoding element coupled to the media input element. The apparatus further includes a first media encoding element coupled to the media input element and the first media output element. The apparatus further includes a second media encoding element coupled to the media input element and the second media output element.

In various embodiments of the present invention, an apparatus for encoding two or more media streams is provided. The apparatus comprises a media input element, a first media output element and a second media output element. The apparatus further includes a multiple output media encoding element coupled to the media input element, the first media output element and the second media output element.

In various embodiments of the present invention, a method of encoding two or more video outputs utilizing a common module is provided. The method comprises producing media information at the common module and a first video stream utilizing the media information. The first video stream is characterized by a first characteristic. The method further includes producing a second video stream utilizing the media information. The second video stream is characterized by a second characteristic different to the first characteristic.

In various embodiments of the present invention, a method for encoding two or more video outputs is provided. The method includes processing using an encoding process to produce intermediate information. The method further includes processing using a first incremental process utilizing the intermediate information to produce a first video output. The method further includes processing using a second incremental process to produce a second video output.

An apparatus for transcoding between H.264 format and VP8 format is provided. The apparatus comprises an input module and a decoding module coupled to the input module. The decoding module includes a first media port and a first assistance information port and is adapted to output media information on the first media port and assistance information on the first assistance information port. The apparatus further comprises an encoding module. The encoding module has a second media port coupled to the first media port and a second assistance information port coupled to the first assistance information port. The apparatus further comprises an output module coupled to the encoding module.

Embodiments of the present invention provide one or more of the following benefits: save processing cost, for example in computation and bandwidth, reduce transmission costs, increase media quality, provide an ability to reach more devices, enhance a user's experience through quality adaptive streaming/delivery of media and interactivity with media, increase the ability to monetize content, increase storage effectiveness/efficiency and reduce latency for content delivery. In addition a reduction in operating costs and a reduction in capital expenditure is gained by the use of these embodiments.

Depending upon the embodiment, one or more of these benefits, as well as other benefits, may be achieved. The objects, features, and advantages of the present invention, which to the best of our knowledge are novel, are set forth with particularity in the appended claims.

The present invention, both as to its organization and manner of operation, together with further objects and advantages, may best be understood by reference to the following description, taken in connection with the accompanying drawings.

### BRIEF DESCRIPTION OF THE ACCOMPANYING DRAWINGS

The present invention is described by way of embodiments illustrated in the accompanying drawings wherein:

FIG. 1 illustrates a content adapter deployed between one or more terminals and one or more media sources according to an embodiment of the present invention.

FIG. 2 shows element assistance information being passed between elements of a media processing pipeline, in accordance with an embodiment of the present invention.

FIG. 3A illustrates an embodiment of media processing element assistance provided by a media processing element to another media processing element.

FIG. 3B illustrates encoder assistance information provided by a decoder to an encoder along with addition of a “modification” element in the transcoding pipeline.

FIG. 3C illustrates encoder assistance information provided by a decoder to an encoder along with an “addition” element in the transcoding pipeline.

FIG. 4 illustrates peer media processing element assistance, in accordance with an embodiment of the present invention.

FIG. 5A illustrates media processing elements providing peer assistance information to each other where the elements are using same media information

FIG. 5B illustrates encoders providing peer encoder assistance information to each other where the encoders are using related but somehow modified media information.

FIG. 6A illustrates utilizing assistance information for transrating according to one embodiment of the invention;

FIG. 6B illustrates assistance information for transcoding with frame rate conversion according to one embodiment of the invention;

FIG. 6C illustrates assistance information for transcoding with frame size conversion according to one embodiment of the invention;

FIGS. 7A and 7B illustrate saving of information on media processing pipeline and utilizing the information later for processing media.

FIG. 8 illustrates a media pipeline that stores assistance information from multiple elements in the pipeline

FIGS. 9A, 9B and 9C illustrate reading and writing of data by elements of a pipeline in cache memory and to other processing elements in the pipeline.

FIG. 10A illustrates a processing element with a receiver and a cache according to one embodiment of the invention;

FIG. 10B illustrates a processing element after a receiver has disconnected according to one embodiment of the invention;

FIG. 10C illustrates a processing element storing its state according to one embodiment of the invention;

FIG. 10D illustrates a second receiver and a cache according to one embodiment of the invention;

FIG. 10E illustrates a processing element restoring its state according to one embodiment of the invention;

FIG. 10F illustrates a processing element with a second receiver and a cache according to one embodiment of the invention;

FIG. 11A illustrates a processing pipeline running according to one embodiment of the invention;

FIG. 11B illustrates a processing pipeline pausing according to one embodiment of the invention;

FIG. 11C illustrates a processing pipeline resuming according to one embodiment of the invention;

FIG. 12A illustrates forking of an element's output according to an embodiment of the invention;

FIG. 12B illustrates forking of a pipeline according to another embodiment of the invention;

FIG. 13 illustrates forking of a pipeline to produce still images according to an embodiment of the invention.

FIG. 14A illustrates access information for a content according to an embodiment of the invention;

FIG. 14B illustrates processed portions for a content according to an embodiment of the invention;

FIG. 14C illustrates iterative processing of media content according to an embodiment of the invention;

FIG. 15 illustrates seekable spliced content according to one embodiment of the invention;

FIG. 16A illustrates a receiver seeking seekable content according to one embodiment of the invention;

FIG. 16B illustrates a receiver unable to seek non-seekable content according to one embodiment of the invention;

FIG. 17 illustrates a receiver unable to seek seekable content after processing according to an embodiment of the invention;

FIG. 18 illustrates a receiver able to seek seekable content after processing according to another embodiment of the invention;

FIG. 19A illustrates producing “seekability” information from non-seekable content according to one embodiment of the invention;

FIG. 19B illustrates a receiver able to seek non-seekable content after processing using “seekability” information according to one embodiment of the invention;

FIG. 20A illustrates high level architecture of a Multiple Output encoder;

FIG. 20B illustrates general internal structure of the MO encoder;

FIG. 21A illustrates three independent encoders encoding one intra-frame for multiple output bitrates according to one embodiment of the invention;

FIG. 21B illustrates an MO encoder encoding one intra-frame for multiple output bitrates according to one embodiment of the invention.

FIGS. 22A-22B illustrate a flowchart to determine common intra-frames in an MO encoder for multiple output bitrates according to one embodiment of the invention.

FIGS. 23A-23B illustrate a flowchart for encoding an IDR or an intra-frame in an MO encoder for multiple output bitrates according to one embodiment of the invention.

FIG. 24A illustrates a common high-level structure of the H.264 encoder and the VP8 encoder.

FIG. 24B illustrates a common high-level structure of the H.264 encoder and the VP8 encoder.

### DETAILED DESCRIPTION OF THE INVENTION

A Multimedia/Video Adaptation Apparatus and methods pertaining to it are described in U.S. patent application Ser. No. 12/029,119, filed Feb. 11, 2008 and entitled “METHOD AND APPARATUS FOR THE ADAPTATION OF MULTIMEDIA CONTENT IN TELECOMMUNICATIONS NETWORKS” and the apparatus and methods are further described in U.S. patent application Ser. No. 12/554,473, filed Sep. 4, 2009 and entitled “METHOD AND APPARATUS FOR TRANSMITTING VIDEO” and U.S. patent application Ser. No. 12/661,468, filed Mar. 16, 2010 and entitled “METHOD AND APPARATUS FOR DELIVERY OF ADAPTED MEDIA”, the disclosures of which are hereby incorporated by reference in their entirety for all purposes. The media platform disclosed in the present invention allows for deployment of novel applications and can be used as a platform to provide device and network optimized adapted media amongst other uses. The disclosure of the novel methods, services, applications and systems herein are based on Content Adaptor platform. However, one skilled in the art will recognize that the methods, services, applications and systems, may be applied on other platforms with additions, removals or modifications as necessary without the use of the inventive faculty.

In various embodiments, methods and apparatuses disclosed by the present invention can adapt media for delivery in multiple formats of media content to terminals over a range of networks and network conditions and with various differing services.

Various embodiments of the present invention disclose the use of just-in-time real-time transcoding, instead of off-line transcoding which is more costly in terms of network bandwidth usage.

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purpose of clarity, details relating to technical material that is known in the technical fields related to the invention have been briefly described or omitted so as not to unnecessarily obscure the present invention.

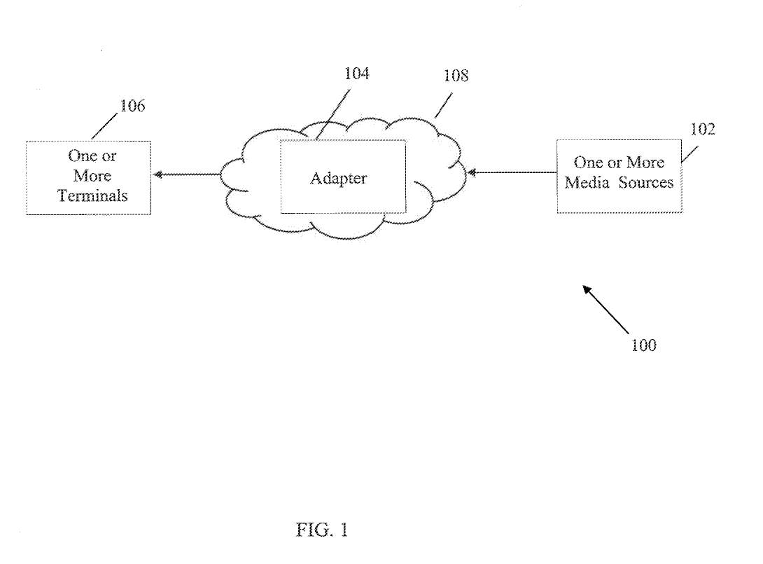

FIG. 1 illustrates an adapter deployed between one or more terminals and one or more media sources according to an embodiment of the present invention. One or more media sources 102 may include sources such as live encoders, content servers, streaming servers, media switches and routers, terminals, and so on. The one or more media sources 102 may be part of an organization providing media content to one or more terminals 106 through a Communication network 108. The one or more media sources 106 are configured to provide media services such as media streaming, video sharing, video mail and other services. Communication network 108 is a telecommunication network of an operator or service provider delivering media content on behalf of the organization. Examples of Communication network 108 may include wired Local Area Network (LAN), wireless LAN, Wi-Fi network, WiMax network, broadband internet, cable internet and other existing and future packet-switched networks. The one or more terminals 106 may represent a wide range of terminals, including laptops, Personal Computers PCs, set-top (cable/home theatre) boxes, Wi-Fi hand-held devices, 2.5G/3G/3.5G (and their evolutions) data cards, smartphones, portable media players, netbooks, notebooks, tablets, desktops, notepads etc.

Adapter 104 may be deployed by operators and service providers within Communication network 108. Media traffic received from the one or more media sources 102 can be adapted based on number of conditions, factors and policies. In various embodiments of the present invention, Adapter 104 is configured to adapt and optimize media processing and delivery between the one or more media sources 102 and the one or more terminals 106.

In various embodiments of the present invention, Adapter 104 may work as a media proxy. Communication network 108 can redirect all media requests such as local or network file reads of all media container formats, HTTP requests to all media container formats, all RTSP URLs, SIP requests through the Adapter 104. Media to the one or more terminals 106 is transmitted from the one or more media sources 102 or other terminals through Adapter 104.

In various embodiments of the present invention, Adapter 104 can be deployed by operators and service providers in various networks such as mobile packet (2.5G/2.75G/3G/3.5G/4G and their evolutions), wired LAN, wireless LAN, Wi-Fi, WiMax, broadband internet, cable internet and other existing and future packet-switched networks.

Adapter 104 can also be deployed as a central feature in a converged delivery platform providing content to wireless devices, such as smart phones, netbooks/notebooks, tablets and also broadband devices, such as desktops, notepads, notebooks and tablets.

In an embodiment of the present invention, Adapter 104 can adapt the media for live and on demand delivery to a wide range of terminals, including laptops, PCs, set-top (cable/home theatre) boxes, Wi-Fi hand-held devices, 2.5G/3G/3.5G (and their evolutions) data card and mobile handsets.

In various embodiments of the present invention, Adapter 104 includes a media optimizer (described in U.S. patent application Ser. No. 12/661,468, filed Mar. 16, 2010 and entitled “METHOD AND APPARATUS FOR DELIVERY OF ADAPTED MEDIA”).

Media Optimizer of Adapter 104 can adapt media to different bitrates and use alternate codecs from the one or more media sources 102 for different terminals and networks with different bandwidth requirements. The adaptation process can be on-the-fly and the adapted media may work with native browsers or streaming players or applications on the one or more terminals 106. The bit-rate adaptation can happen during a streaming session (dynamically) or only at the start of new session.

The media optimizer comprises a media input handler and a media output handler. The media input handler can provide information about type and characteristics of incoming media content from the one or more media sources 102, or embedded/meta information in the incoming media content to an optimization strategy controller for optimization strategy determination. The media output handler is configured to deliver optimized media content to the one or more terminals 106 by using streaming technologies such as RTSP, HTTP, SIP, RTMP, XMPP, and other media signaling and delivery technologies. Further, the media output handler collects client feedbacks from network protocols such as RTCP, TCP, and SIP and provides them to the optimization strategy controller. The media output handler also collects information about capabilities and profiles of the one or more terminals 106 from streaming protocols such as user agent string, Session Description Protocol, or capability profiles described in RDF Vocabulary Description Language. Further, the media output handler provides the information to the optimization strategy controller.

The media optimizer may adopt one or more policies for adapting and optimizing media content for transfer between the one or more media sources 102 and the one or more terminals 106. In an embodiment of the present invention, a policy can be defined to adapt incoming media content to a higher media bit-rate for advertisement content or pay-per-view content. This policy can be used to ensure advertiser satisfaction that their advertising content was at an expected quality. It may also be ensured that such “full-rate” media is shifted temporally to not be present on multiple channels at the same time.

In another embodiment of the present invention, a policy can be defined to reduce media bit-rate for users that are charged for amount of bits received such as data roaming and pay-as-you-go users, or depending on availability of network bandwidth and congestions.

In yet another embodiment of the present invention, a policy can be defined to adapt the media to Multiple Bitrates Output (MBO) simultaneously and give the choice of the bitrate selection to the client.

In yet another embodiment of the present invention, optimization process performed by media optimizer utilizes block-wise processing, i.e. adapting content sourced from the one or more media sources 102 dynamically rather than waiting for entire content to be received before it is processed. This allows server headers to be analyzed as they are returned, and allows the content to be optimized dynamically by adapter 104. This confers the benefit of low delay in processing and is unlikely to be perceptible to a user. In an embodiment of the present invention, Adapter 104 may also control data delivery rates into Communication network 108 (not just media encoding rates) that would otherwise be under the control of the connection between the one or more terminals 106 and the one or more media sources 102.

Further, Adapter 104 comprises one or more media processing elements co-located with the media optimizer and configured to process media content. In various embodiments of the present invention, a media processing element may include a content adapter co-located with Adapter 104 and provide support for various input and output characteristics. A content adapter is described in U.S. patent application Ser. No. 12/029,119, filed Feb. 11, 2008 and entitled “METHOD AND APPARATUS FOR THE ADAPTATION OF MULTIMEDIA CONTENT IN TELECOMMUNICATIONS NETWORKS” the disclosure of which is hereby incorporated by reference in its entirety for all purposes. Video compression formats that can be provided with an advantage by Adapter 104 include: MPEG-2/4, H.263, Sorenson H.263, H.264/AVC, WMV, On2 VPx (e.g. VP6 and VP8), and other hybrid video codecs. Audio compression formats that can be provided with an advantage by Adapter 104 may include: MP3, AAC, GSM-AMR-NB, GSM-AMR-WB and other audio formats, particularly adaptive rate codecs. The supported input and output media file formats that can be provided with an advantage with Adapter 104 include: 3GP, 3GP2, .MOV, Flash Video (FLV), MP4, .MPG, Audio Video Interleave (AVI), Waveform Audio File Format (.WAV), Windows Media Video (WMV), Windows Media Audio (WMA) and others.

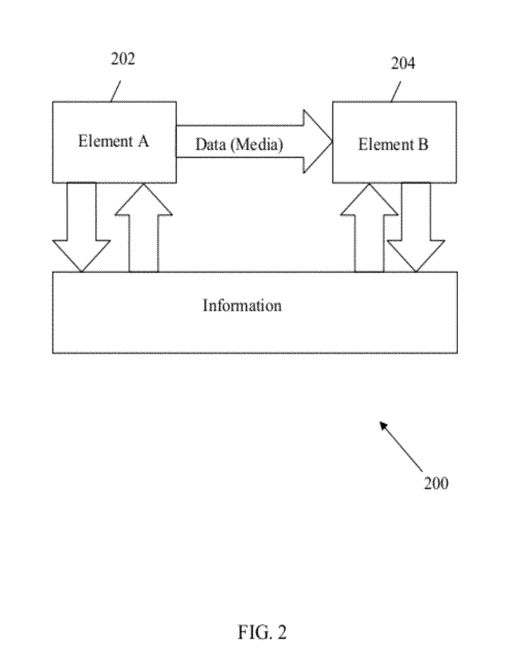

FIG. 2 shows element assistance information being passed between elements of a media processing pipeline, in accordance with an embodiment of the present invention. The figure shows a high-level architecture of a smart media processing pipeline illustrating flow of media data and information between Element A 202 and Element B 204. Though the figure uses two distinct flows distinguishing the transmissions of data and assistance information, embodiments of the present invention do not necessarily require data and information to be transmitted on different data paths. In various embodiments of the present invention, Element A 202 and Element B 204 are media processing elements which are part of a media processing pipeline configured to adapt and/or optimize media delivery between one or more media sources and one or more terminals.

Element Assistance Information (EAI) is provided by Element A 202 to Element B 204 in order to perform adaptation and optimization of media content derived from the one or more media sources. EAI is provided by Element A 202 to Element B 204 along with media data and is used by Element B 204 for processing media data. In various embodiments of the present invention, Element Assistance Information is provided by Element A 202 to Element B 204 so as to minimize processing in Element B 204 by providing hinted information from Element A 202. EAI is used in Element B to increase its efficiency in processing of media data, such as session throughput on given hardware, quality or adherence to a specified bitrate constraint.

In various embodiments of the present invention, EAI channel does not flow in the same direction as the media. EAI can be provided by Element B 204 to Element A 202. Information provided to Element A 202 may include specifics on how outputs of Element A 202 are to be used. In an embodiment of the present invention, the information provided to Element A 202 allows it to optimize its output. For example, based on EAI received from Element B 204, Element A 202 produces an alternate or modified version of the output to what is normally produced. A downscaled or down-sampled version of the output may be produced by Element A 202, where the resolution to be used in Element B 204 is reduced as compared to Element A 202.

In various embodiments of the present invention, EAI and media data is provided by Element A 202 to Element B 204 in common data structures, interleaved or in separate data streams and are provided at the same time.

In an embodiment of the present invention, the processing pipeline may be a media transrating/transcoding pipeline. In the pipeline, Element A 202 may be a decoder element that decodes input bitstream and produces raw video data. The raw video data may be passed to a video processing element for operations such as cropping, downsizing, frame rate conversion, video overlay and so on. The processed raw video will be passed to Element B 204, for example, an encoder element for performing compression. Along with the raw video, transcoding information extracted from the decoder may also be passed from the decoder element to the encoder element.

EAI may be partially decoded data that can characterize input media, such as macroblock mode, macroblock sub-mode, quantization parameter (QP), motion vector, coefficients etc. An encoder element can utilize EAI to reduce complexity of many encoding operations, such as rate control, mode decision and motion estimation and so on.

In cases where media adaptation is a transrating session, encoder assistance information may include a count of bits and actual encoded bits. Providing the encoded bits is useful for transcoding, pass-through and transrating. In some cases the actual bits may be used in the output either directly or in a modified form.

Encoder assistance motion information may be modified in a trans-frame-rating pipeline to reflect changes in the frames present, such as dropped or interpolated frames. For example operations might include, adding vectors, defining bits used, averaging other features etc. In some embodiments, information such as the encoded bits (from the bitstream) may not be useful to send and may be omitted.

For rate control, critical EAI may be bit count of media data. Bit count provided for an encoded media feature, such as frame, or macroblock allows for reduced processing during rate control. For removing a certain proportion of bits, for example, reducing bitrate by 25%, reuse of source bit sizes modified by a reduction factor provides a useful starting point.

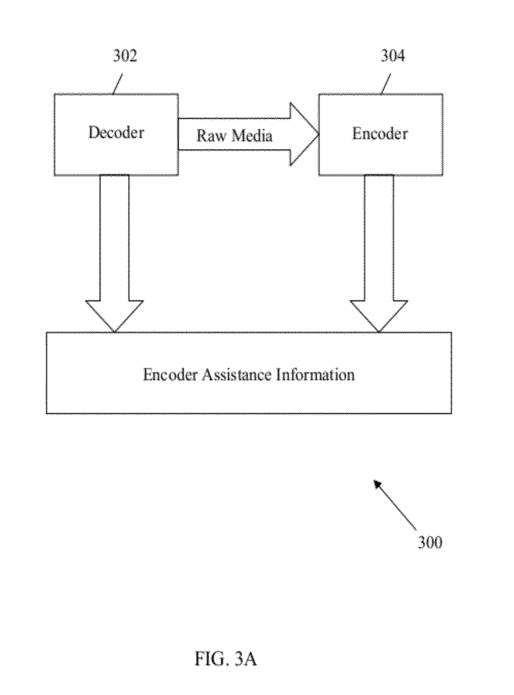

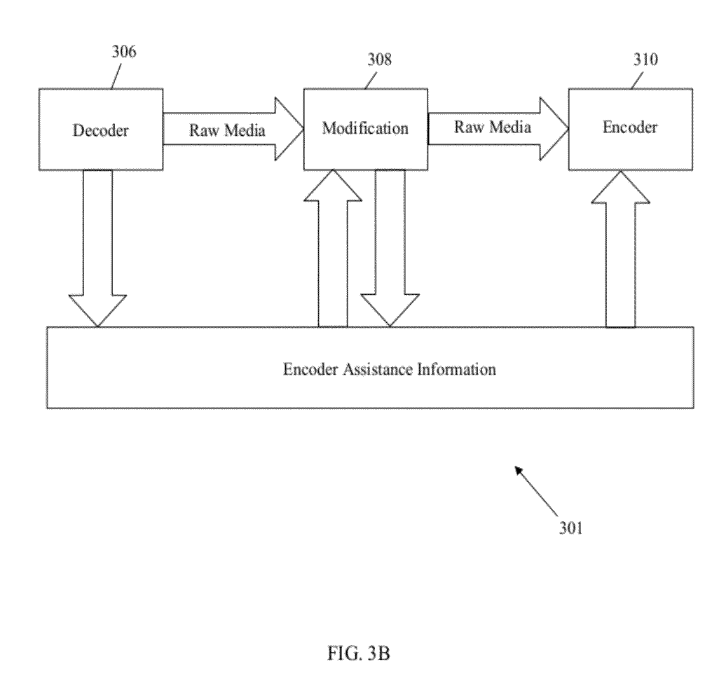

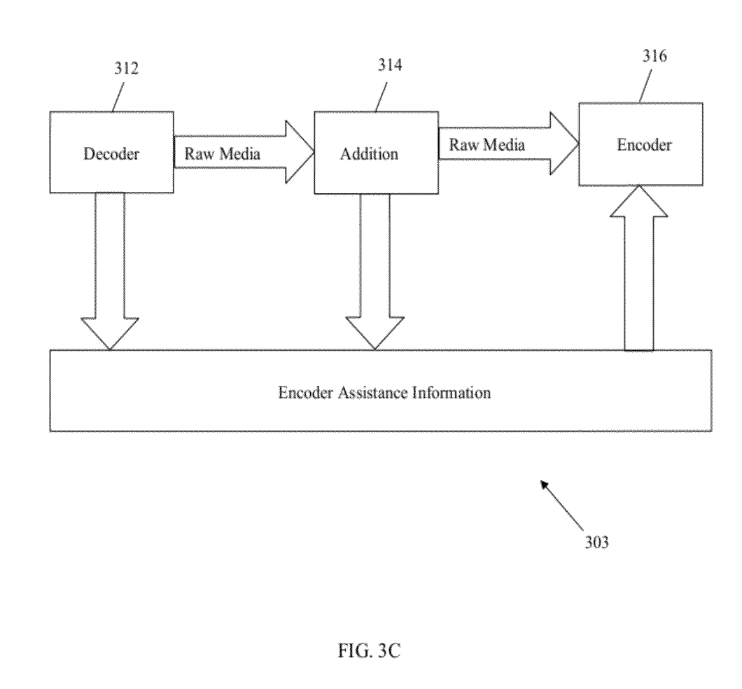

FIG. 3A illustrates an embodiment of media processing element assistance provided by a media processing element to another media processing element. As shown in the figure, Decoder 302 is an upstream media processing element and Encoder 304 is a downstream media processing element. In various embodiments of the present invention, Decoder 302 and Encoder 304 are part of a media processing pipeline configured to adapt and/or optimize media data.

In an embodiment of the present invention, Decoder 302 decodes an input bitstream and produces raw video data. Raw video data is passed along with Encoder Assistance Information from Decoder 302 to Encoder 304. Encoder Assistance Information is generated at Decoder 302 from the input bitstream. Encoder Assistance Information is used to assist Encoder 304 in media processing. In various embodiments of the present invention, encoder assistance information is used for processing media such as audio streams, video streams as well as other media data.

In various embodiments of the present invention, application of assistance information to a downstream element need not be limited to a decoder-encoder relationship but is also applicable to cases where modification of media occurs, as illustrated in FIG. 3B or to cases where an addition to media occurs, as illustrated in FIG. 3C. FIG. 3B illustrates addition of a “modification” element between the Decoder 306 and Encoder 310. Modification element 308 might provide functionality as temporal or spatial scaling, aspect ratio adjustment and padding and/or cropping. In this case media data and encoder assistance information are both modified in a complementary way in the modification element. Modification element 308 may also be used to convert decoder information to encoder-ready information if codecs used in Decoder 306 and Encoder 310 do not match exactly. In this way functional logic used for decoding/encoding need not be located deep inside media processing elements but is instead more readily usable to assist in processing conversion.

Modification element 308 need not necessarily be a single element, and may consist of a pipeline which may have both serial and parallel elements. The modification of the data and information need not necessarily be conducted in a single element. Parallel processing or even “collapsed” or all-in-one processing of the information, where only a single element exists to conduct all necessary conversion on the information, may be beneficial in various regards, such as CPU usage, memory usage, locality of execution, network or I/O usage, etc. if multiple operations are performed on data.

FIG. 3C illustrates an addition element 314 that may provide data onto the information pipeline from Decoder 312 to Encoder 316, but need not modify incoming information. Examples of providing data without modification may include cases of image or video overlay where it will be sufficient to indicate to Encoder 316 that a particular region has been changed but it is not directly possible to modify other encoder assistance information. As illustrated in the figure, Encoder Assistance information may be provided by Decoder 312 to Encoder 316 along with transfer of “raw media” with addition element 314 added to the media.

In an exemplary embodiment of the present invention, an information addition element for video data is a processing element that determines a Region of Interest (ROI) to encode. The information provided to Encoder 316, in addition to other encoder assistance information related to Decoder 312, can be used to encode areas, not in the ROI with coarser quality and fewer bits. The ROI can be determined by content types like news, sports, or music TV, or may be provided in meta-data. Another technique is to perform a texture analysis of video data. The regions that have complex texture information need more bits to encode but they may not be important to a viewer especially in video streaming application. For example in a basketball game, the high texture areas (like the crowd or even the parquetry) may not be as interesting since viewers tend to focus more on the court area, the players and more importantly on the ball. Therefore, the lower texture area of the basketball court is significantly more important to reproduce for an enhanced quality of experience.

With reference to FIGS. 3A, 3B and 3C, element assistance information can be sent upstream instead of downstream. For example, element assistance information can be sent from an encoder, or other later processing elements, back to the decoder to help the decoder optimize its processing. In an exemplary embodiment of the present invention, during down-sampling of media signals, such as when image size reduction occurs in a later pipeline, the downstream elements can provide information regarding image size reduction to the upstream elements. The decoder in this case will be able to optimize its output to produce possibly the correct size, saving on the decoding effort, external scaling and extra processing and copying, or simply downsizing to a more convenient size, such as the nearest multiple of two that is still larger to reduce bandwidth and scaling effort.

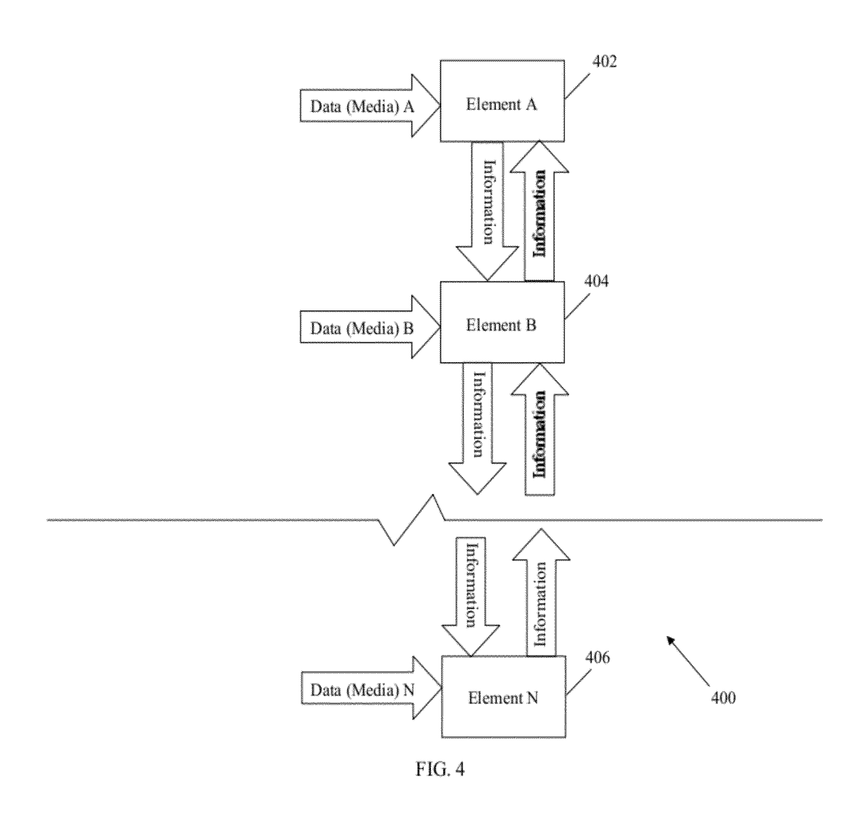

FIG. 4 illustrates peer media processing element assistance, in accordance with an embodiment of the present invention. As shown in the figure, multiple encoders, i.e. Element A 402, Element B 404 and Element N 406 use related inputs i.e. each encoder receives a portion of media data as input. Further, each encoder generates a distinct output. Encoder assistance information is generated at Element A 402 in its processing of media and is provided to Element B 404 to assist Element B 404 in media processing. The information may be used and passed to separate encoders from the first encoder or they might form a chain of refinement in some circumstances, as shown in the figure.

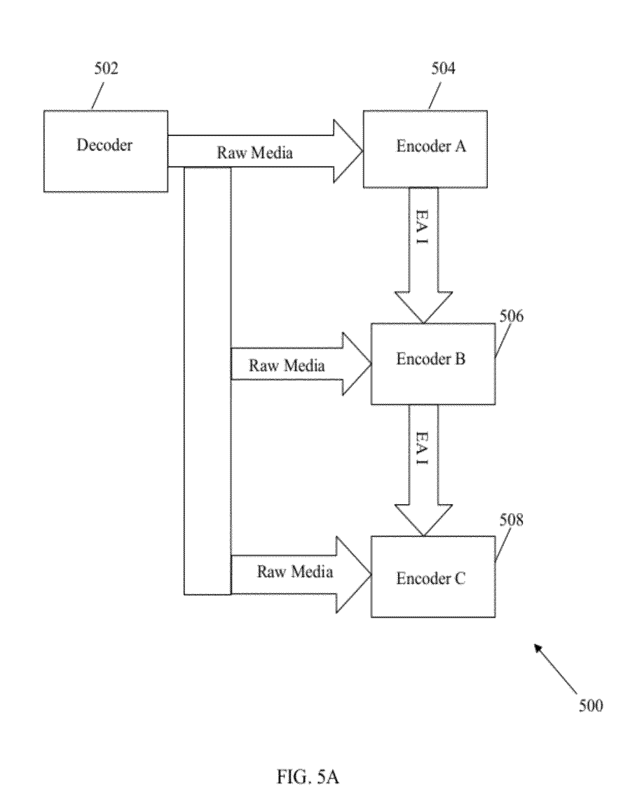

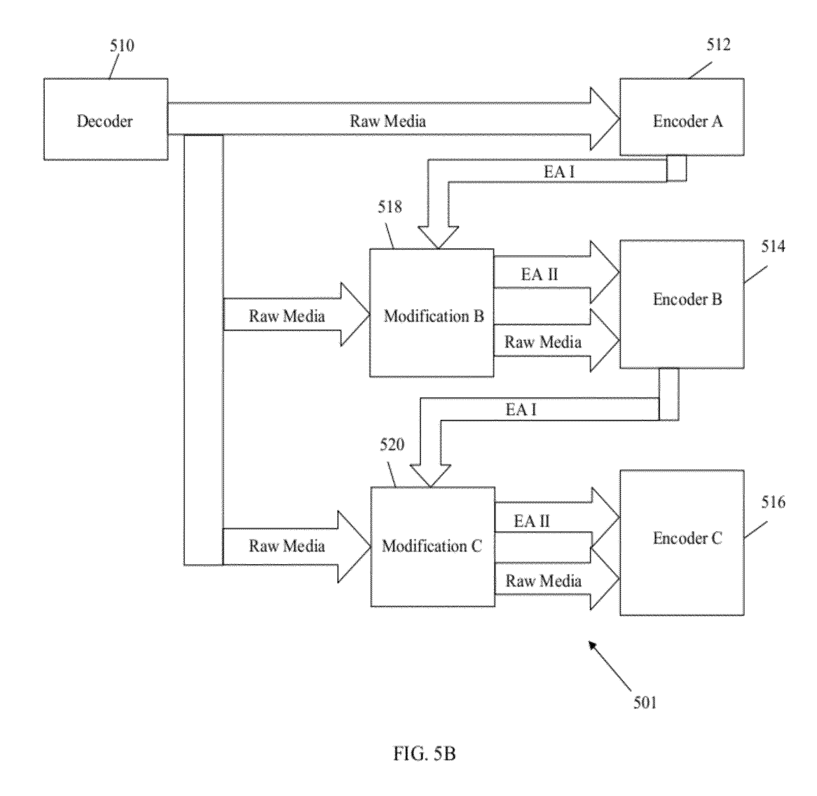

FIG. 5A illustrates media processing elements providing peer assistance information to each other where the elements are using same media information. Scenarios where media processing elements may provide peer assistance information to each other may include the case where media encoders receive common media input and produce outputs with varying bitrates but the same media size and frame rates. A real life case may be a plurality of customers using similar media players and accessing the same content but at different rates depending on the network they are attached to e.g. [128 kbps network, 300 kbps network and 500 kbps]. In the aforementioned scenario, since the same content is accessed, media encoders delivering the content may share information for processing raw media data.

As shown in the figure, Encoder A 504, Encoder B 506 and Encoder C 508 process raw media data and provide element assistance information to each other for processing the media data. In various embodiments of the present invention, the assistance information can be shared via message passing, remote procedure calls, shared memory, one or more hard disks, pipeline message propagation system (whereby elements can “tap” into or subscribe to a bus that contains all assistance information and they can receive all the information or a filtered subset applicable to their situation).

In an embodiment of the present invention, an optimized H.264 Multiple Bitrate Output (MBO) encoder implements encoding instances that share assistance information. The H.264 MBO encoder consists of multiple encoding instances that encode the same raw video to different bitrates. After finishing encoding one particular frame, the first encoding instance in the MBO encoder can provide the assistance information to other encoding instances. The assistance information can include macroblock mode, prediction sub-mode, motion vector, reference index, quantization parameter, number of bits to encode, and so on. The assistance information is a good characterization of the video frame to be encoded. For example, if it is known a macroblock is encoded as a skip macroblock in the first encoding instance, it means that the macroblock can be most likely encoded as a skip in other encoding instance too. The processing of skip macroblock detection can be saved. Further, if a reference index is known, a peer encoding process can avoid doing motion estimation in all other reference frames.

FIG. 5B illustrates encoders providing peer encoder assistance information to each other where the encoders are using related but somehow modified media information. As shown in the figure, Encoder B 514 and Encoder C 516 both receive modified media input and modified Encoder Assistance Information input. In various embodiments of the present invention, the modification of EAI need not occur in media modification elements, Modification B 518 and Modification C 520. An element can also provide useful modification of the EAI using what it knows of its own modification on the media stream. For example, a size downscaling element can apply same modifications on the EAI as on the media, based on their timestamps. The modification element might also be involved in EAI conversion steps adapting the information for different codecs.

In certain embodiments of the present invention, sharing of information can occur between encoders in a peer-to-peer fashion where each encoder makes its information available to all the other encoders and the best information is selected. The information may also occur in a hierarchy, where the encoders are ordered based on a dimension such as frame size and the assistance information is propagated along the chain where each element refines the assistance information so that it is more useful for the next. This could be in increasing frame-size, where the hints from the lower resolution serves as good refining starting points which can save significantly on processing if speed is more desired than quality. This could also be in decreasing frame-size, where accuracy of the larger image hints to lower resolution and serves as extremely accurate starting points which can allow for much greater quality. Additionally, EAI information can be sent backwards along the pipeline to allow for the production of several optimized outputs from an initial element to elements using its output.

In various embodiments of the present invention, depending on the processing which is desired, such as a codec being used or frame sizes, a mixture of decoder EAI and one or more peer EAI might be used at a second encoder in a chain of encoders providing peer assistance information to each other.

In various embodiments of the present invention, in addition to providing media related information in EAI, other information which is useful may be provided. For instance provision of a timestamp and duration on the media as well as on the EAI provides an ability to transmit media and EAI separately but ensure processing synchronicity. The ability to process the assistance information based on timing allows for many forms of assistance information combinations to occur.

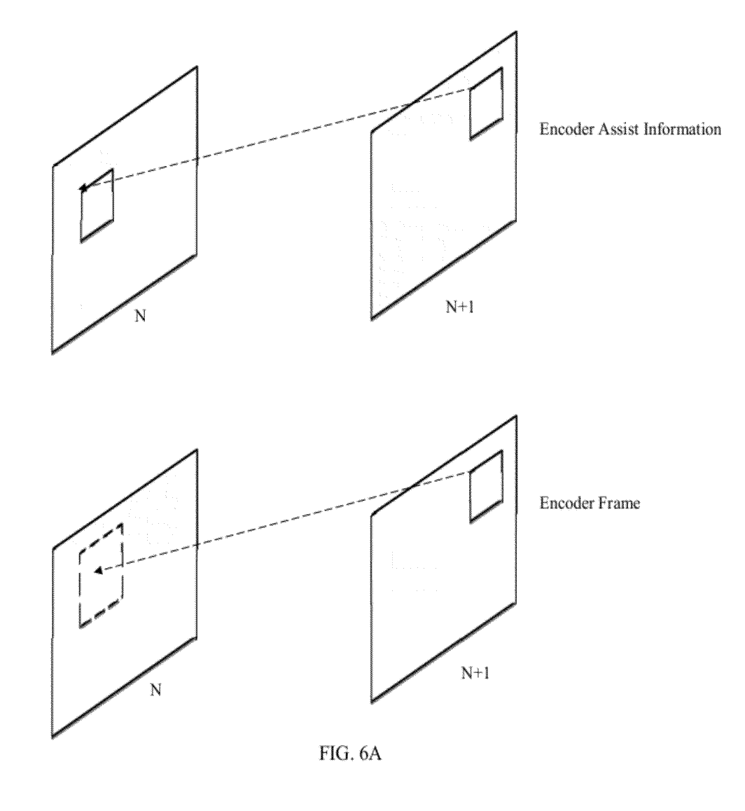

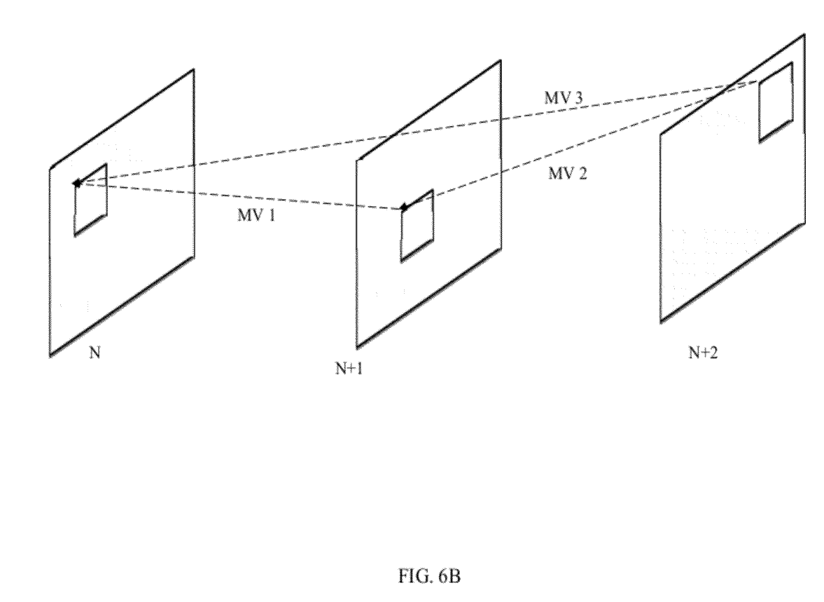

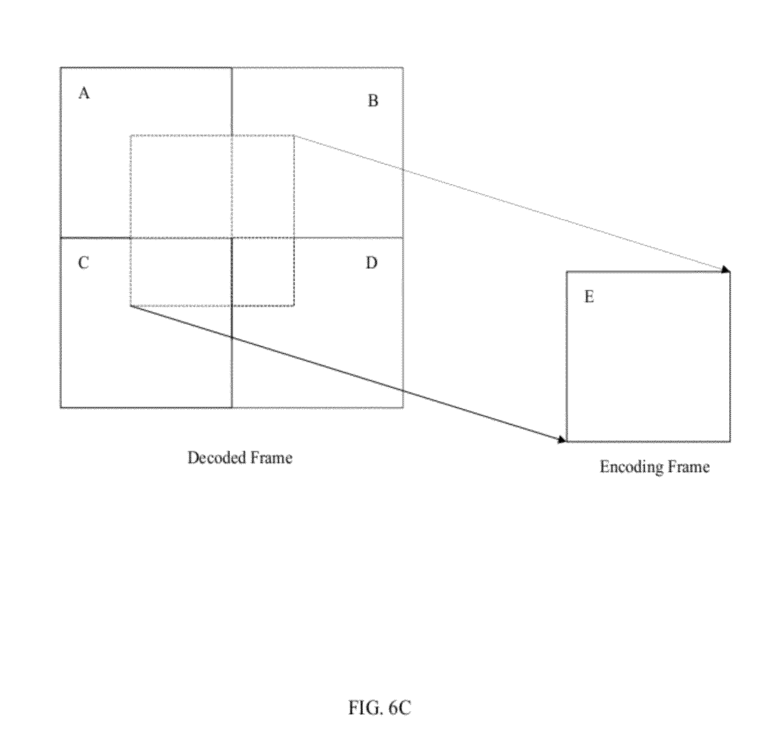

FIG. 6A illustrates utilizing assistance information for transrating according to an embodiment of the invention. The transrating-only scenario refers to the case that the input video and the output video have the same frame rate, video resolution and aspect ratio. In these cases, the video frames that the encoder receives are exactly same as the ones that the decoder produced. This is also useful in the transcoding with codec conversion case where frame size, aspect ratio and frame rate are untouched. As shown in the figure, for encoding the macroblock in Frame N+1, the corresponding transcoding information belonging to this macroblock is found and the transcoding information is then used directly to reduce the encoding complexity of the macroblock. In an embodiment of the present invention, the frame or slice type present in the encoding information is used.

In an embodiment of the present invention, transcoding information is used to optimize motion estimation (ME), mode decision (MD) and rate control. Mode decision is a computationally intensive module, especially in the H.264 encoder. The assistance information optimization techniques are direct MacroBlock (MB) mode mapping and MB mode fast selection. The direct MB mode mapping is to map MB mode from the assistance information to the MB mode for encoding through some MB mode mapping tables. The MB mode mapping tables should handle mapping between the same codec type and between different codec types. The direct MB mode mapping can offer the maximum speed while sacrificing some quality loss. The fast MB mode selection is to use the MB mode information from the assistance information to narrow down MB mode search range in order to improve speed of mode decision. Mode estimation is likewise a computationally intensive module, especially in the H.264 encoder. The assistance information optimization techniques are direct MV transfer, fast motion search and a hybrid of the two. The direct MV transfer is to reuse MV from the assistance information in the encoding. The MV should be processed between different codec types due to the difference in the MV precision. The fast MV search is to use the transferred MV as an initial MV and perform motion search in the limited range. A hybrid algorithm to switch between direct MV reuse and fast search based on bitrate, QP and other factors.

FIG. 6B illustrates frame rate conversion (transcoding information back trace and composition) shows a Motion Vector (MV) back trace for a frame rate conversion. As shown in the figure, there are three consecutive frames and frame N+1 is dropped in the frame rate conversion process. In an embodiment of the present invention, when the macroblock is encoded in the frame N+2, Motion Vector 2 (MV2) in the encoder's motion estimation (ME) is used. However, the reference frame that the MV2 points to is dropped and the reference frame N is used in the encoder. A MV that points from Frame N+2 to Frame N is set up by doing a MV back-trace. As shown in the figure, MV3 is set up by combining MV2 and MV 1.

Usually the block MV2 pointed to in the frame N+1 belongs to multiple macroblocks, where each macroblock has one or more motion vectors. MV1 can be determined by using the motion vector of the dominant macroblock which is the one contributes most data to the block that MV2 points to.

FIG. 6C illustrates transsizing and involves a coding mode decision and MV composition. When the resolution and aspect ratio are changed between the input and output, the transcoding information from the assistance information has to be converted to fit the resolution and aspect ratio of the encoding frame. The macroblock E in the encoding frame is converted from four macroblocks A, B, C, and D in the transsizing process. Based on the percentage of data every macroblock contributes to the macroblock E, the macroblock A is the dominant macroblock because it contributes the most. There are many ways to determine the motion vector of the macroblock E. One way is to use the motion vector of the macroblock A because it is a dominator motion vector. Another way is to use the percentages of data that macroblock A, B, C, and D contributes to macroblock E as weight factors of their motion vectors, to calculate the motion vector of macroblock E.

In various embodiments of the present invention, EAI need not be only used in an active pipeline; it can also be saved for later use. In this case the information may be saved with sufficient information that it can be reused at a later time. For example timestamps and durations, or frame numbers or simple counters can be saved so the data can be more easily processed.

In various embodiments of the present invention, encoders using EAI may be completely different to the codec that produced the information (either the decoder or the encoder). For example converting from H.264 decoding information to H.263 encoding information or with an H.264 encoder peered with a VP8 encoder. In these cases, the encoder assistance information can be firstly mapped to data that are compliant to the encoder standard, and be further refined by doing fast ME and fast mode decision to ensure good quality.

EAI may also be used for multiple pass coding, such as trying to increase quality, or reduce variation in bitrate. It may also be used to generate ‘similar’ output formats rather than process directly from the source content. For example, if a similar bitrate and frame rate has already been generated in the system then this can be used along with EAI data to provide client specific transrating (based on network feedback or other factors). Multi-pass processing increases in quality the more processing iterations that take place. Each pass further produces additional information for other encoders to use.

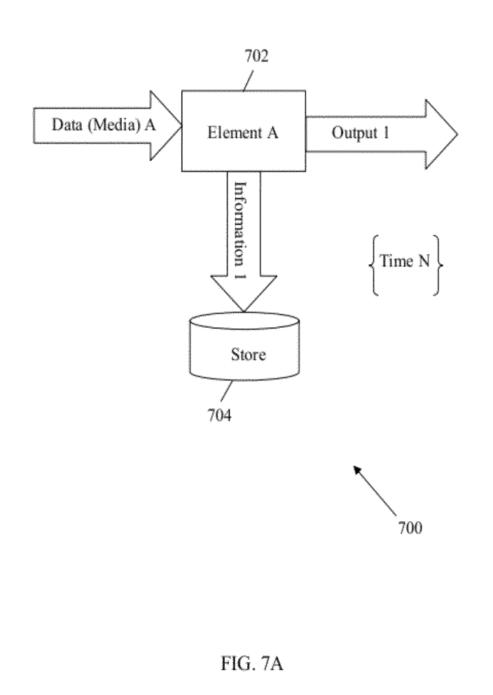

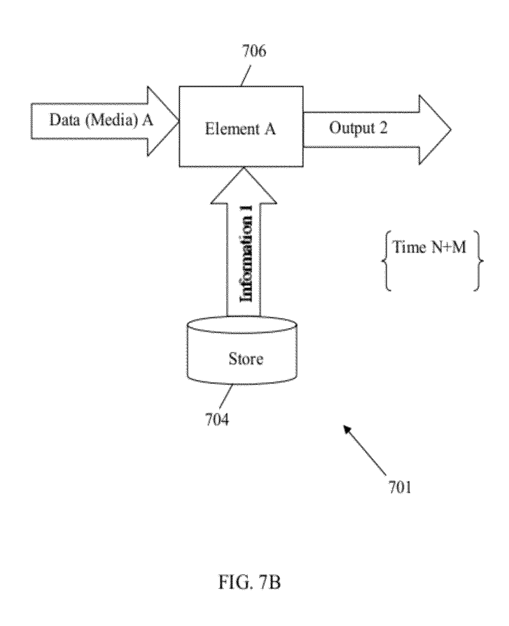

FIGS. 7A and 7B illustrate saving of information on media processing pipeline and utilizing the information later for processing media. FIG. 7A illustrates a first pipeline that produces an output as well as element assistance information. The element assistance information is saved for use in later processing. As shown in the figure, Element A 702 of the pipeline produces an output and element assistance information. During media processing, at time period N, Output 1 is generated and element assistance information is stored at Store 704. Further, at time period N+M, element assistance information generated at time period N is used by the pipeline of FIG. 7B. As shown in the figure, Element B 706 derives the information stored at time period N and uses it to produce an output in order to improve one or more characteristics of media data. In an embodiment of the present invention, the one or more characteristics which may be improved may include media quality or conformance to a specified constrained bitrate.

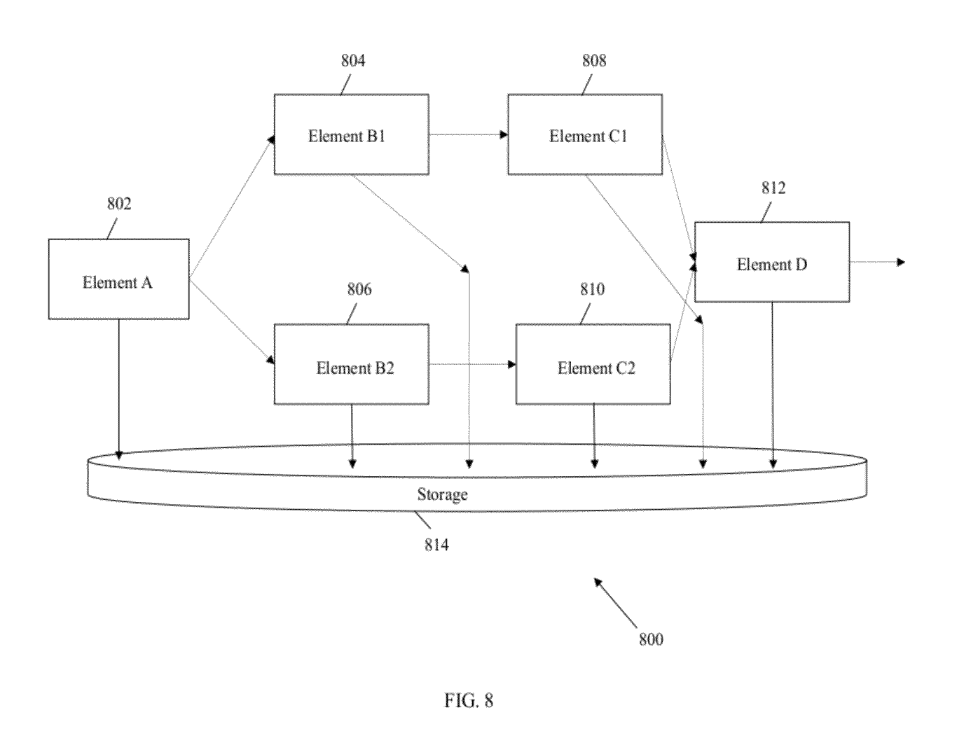

FIG. 8 illustrates a media pipeline that stores assistance information from multiple elements in the pipeline. As shown in the figure, Element A 802, Element B1 804, Element B2 806, Element C1 808, Element C2 810 and Element D 812 store information in Storage 814 for later use.

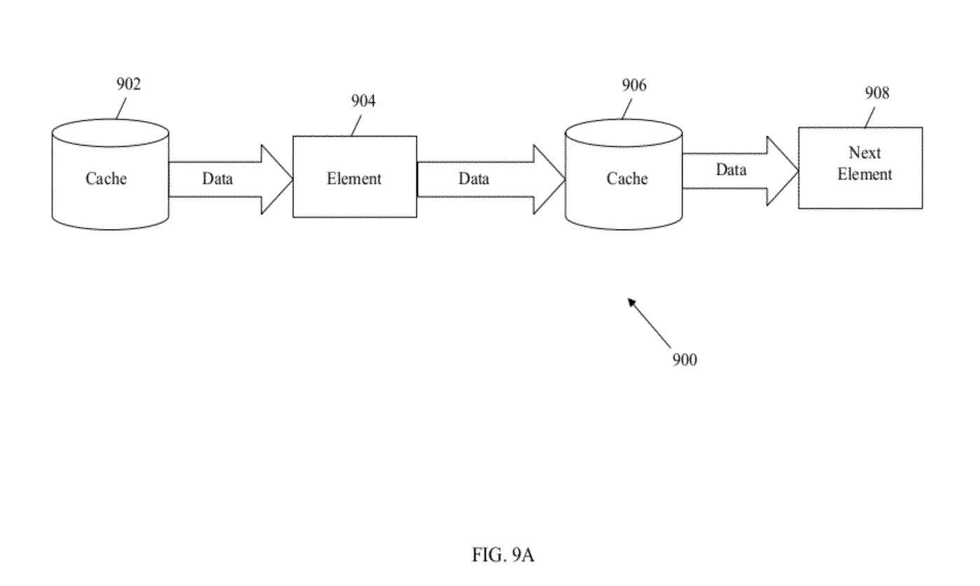

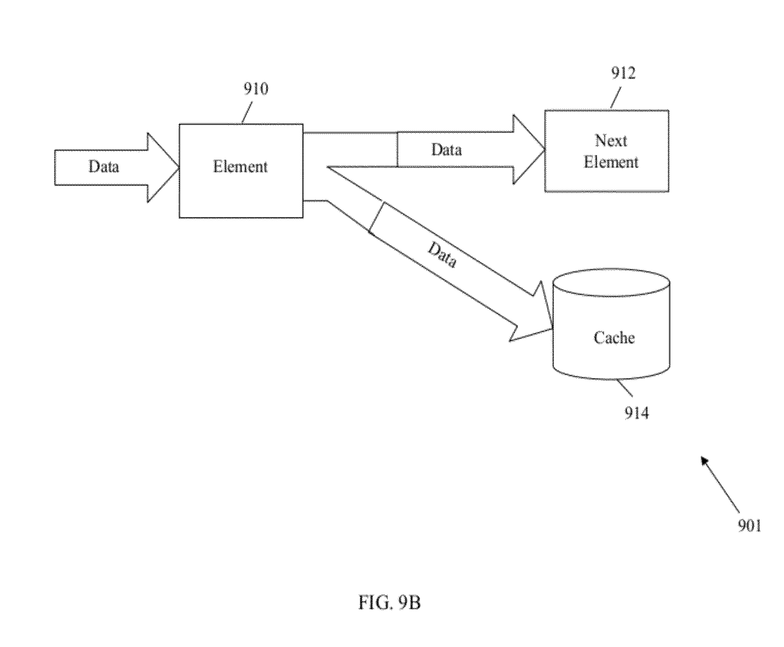

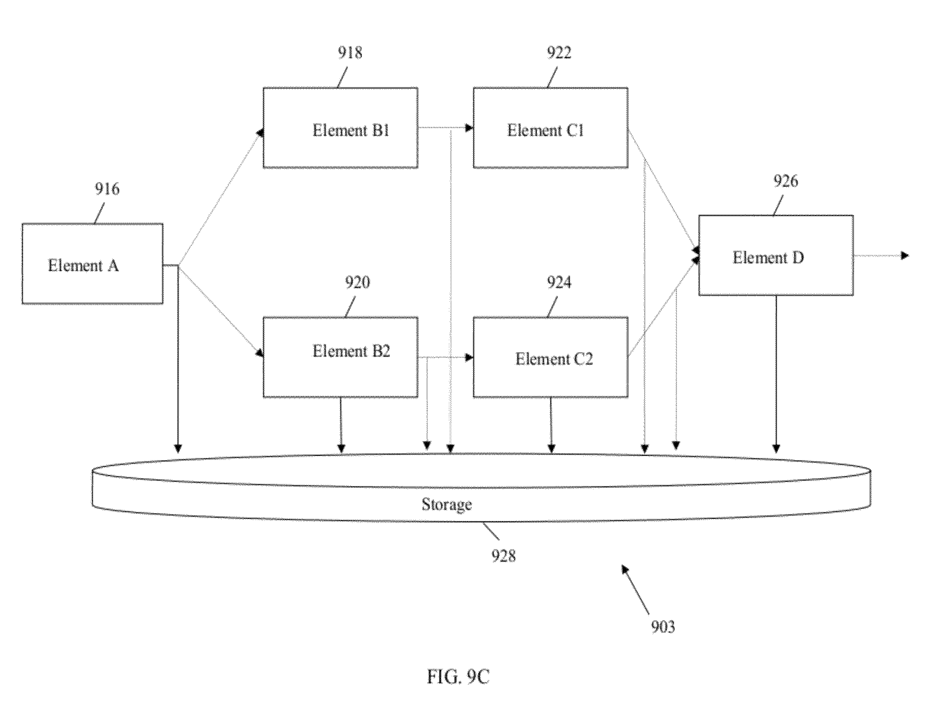

FIGS. 9A, 9B and 9C illustrate reading and writing of data by elements of a pipeline in cache memory and to other processing elements in the pipeline. In various embodiments of the present invention, each element produces an output that is useful in its particular pipeline but the output might also have use in a variety of other pipelines that use the element in the same or similar circumstances. For example, a coded media segment is cacheable and may be used in various situations such as stitching in a playlist or multiplexing to different container or delivery types. In such a case saving the output rather than re-producing it is an efficient strategy. In another example, outputs such as demultiplexed media content, or decoded raw media content may also be useful to be cached in some circumstances depending on tradeoffs involved. Output of any media processing element may be cached for reuse and usefulness depending on the tradeoff. In some instances, an output that may be cached may be something as simple as an integer, for example, frame rate or image width, but the ability to cache the result and avoid recreating a processing pipeline to recreate it will be beneficial in several circumstances.

FIG. 9A illustrates the case where each element in the pipeline 900 reads and writes to cache, whereas FIG. 9B illustrates the case where each element writes to cache as well as to present pipeline's next element. As shown in FIG. 9B, Element 910 writes data to Next Element 912 as well as to cache 914. Data written to cache as well as to Next Element 912 represents intermediate information which is utilized later by the pipeline 901 or by any other pipeline. Heuristics for storing intermediate data includes such things as processing cost, storage cost, Input/Output cost etc. Values of such heuristics can then be used to make storage decisions as well as can be used to decide when an item should be purged from cache. Data which might prove to be costly is removed from the cache.

FIG. 9C illustrates a media processing pipeline 903 where all outputs are cached for later use. As shown in the figure, Element A 916, Element B1 918, Element B2 920, Element C1 922, Element C2 924 and Element D 926 all store data in Storage 928 during processing of media.

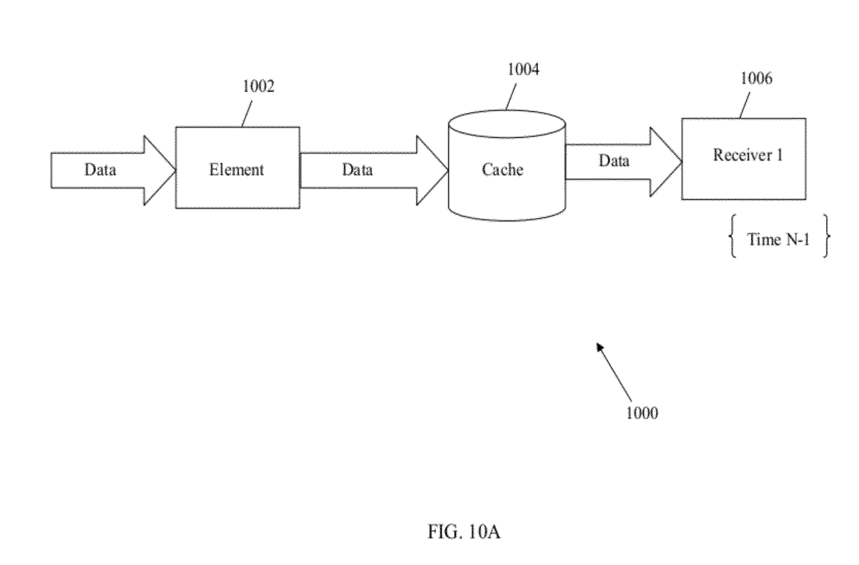

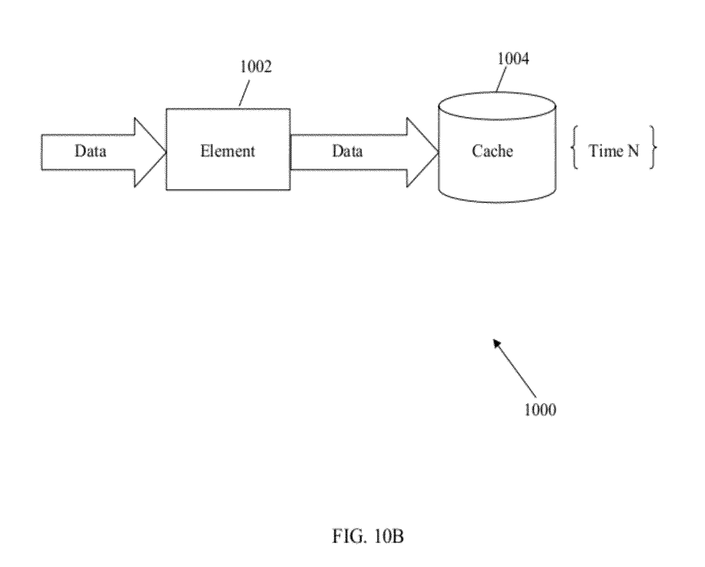

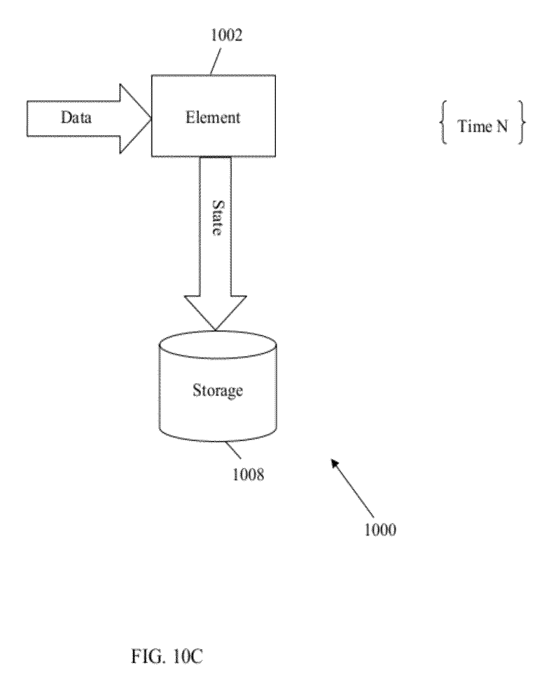

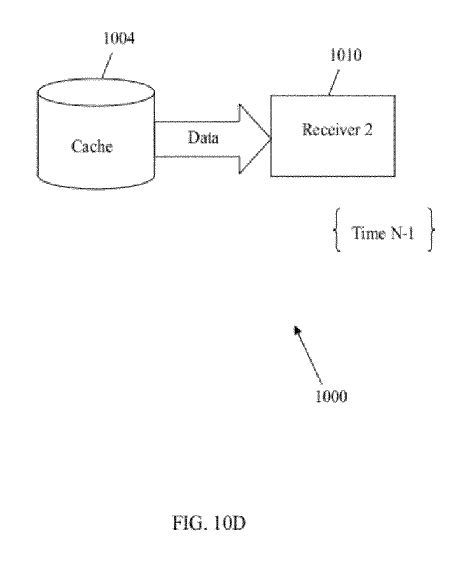

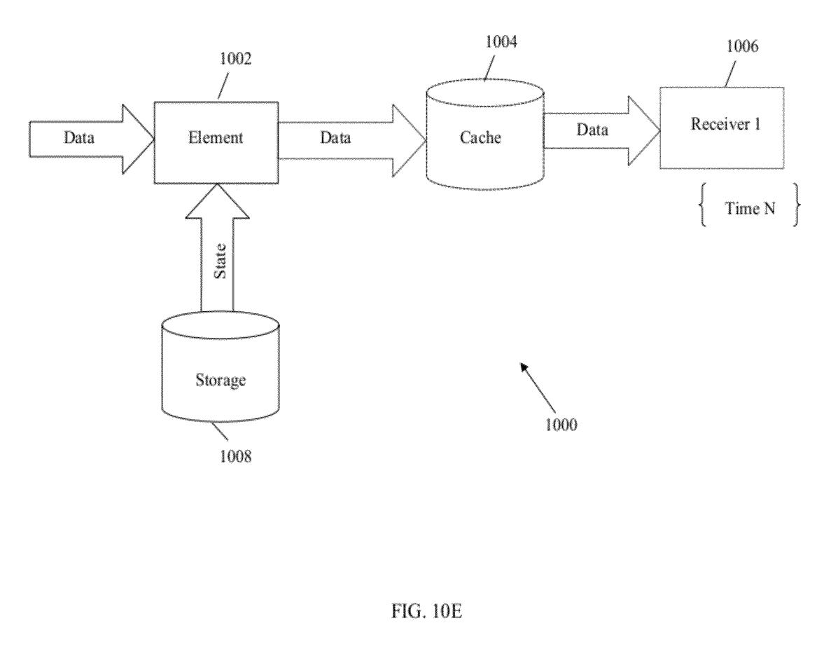

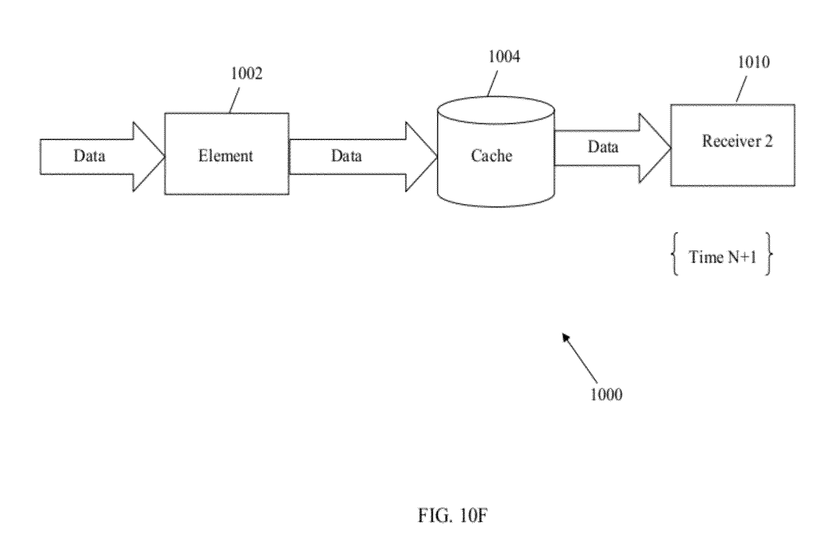

FIGS. 10A, 10B, 10C, 10D, 10E and 10F illustrate halting and restoration of media processing pipelines in the event of momentary cessation of media processing, in accordance with various embodiments of the present invention. In certain scenarios, media processing may be required to be ceased temporarily for various reasons, for example in cases where only a portion of media is needed by a client. For the purposes of optimizing both computational as well as storage efforts, system and method of the present invention provides for stopping the processing of media for a certain period of time and then resuming media processing from the state at which the processing was halted. One of the critical aspects of suspending media processing includes saving the processing state to memory and then restoring the state when the processing is resumed.

FIG. 10A illustrates state of media processing pipeline 1000 at time N−1. Element 1002 in pipeline 1000 processes data and provides the output to Cache 1004 which is read from by Receiver 1 1006. In various embodiments of the present invention, Element 1002 may be a media processing element such as an encoder, a decoder etc. Cache 1004 may be also be read from by other elements apart from Receiver 1 1006. FIG. 10B illustrates disconnection of Receiver 1 1006 from the pipeline 1000, either intentionally or unintentionally at time N. In an exemplary embodiment of the present invention, a client may close its session because the content is not desirable, or the session might be broken because of bad connectivity. FIGS. 10B and 10C illustrate storing of data from Element 1002 in cache and storing of state of Element 1002 at time N, upon disconnection of Receiver 1 1006. FIG. 10B illustrates storing data from Element 1002 to Cache 1004 and FIG. 10C illustrates saving of state of Element 1002 after Receiver 1 1006 is detected as being disconnected. The saving could be to disk, swap or another part of memory although it is not limited to those cases. The saving might be a serialization or simply the de-prioritization of state of Element 1002 or the processing pipeline 1000 such that it is swapped out of memory. Also the state might be saved at a time that is not exactly same as the detection of disconnection. It may roll back to a previous refresh point, such as an H.264 IDR or intra-coded frame, or it may continue processing to produce its next similar refresh point, either on an existing schedule (i.e. periodic key frames) or immediately because of a “disconnect-save”. As shown in FIG. 10C, state of Element 1002 is saved in Storage 1008.

In various embodiments of the present invention, saving the state includes saving everything that is required to resume processing. For an H.263 encoder, data to be saved can be profile, level, frame number, current macroblock position, current Quantization Parameter (QP), encoded bitstream, one reference frame, current reconstructed frame and so on, For an H.264 encoder, things to be saved can be Sequence Parameter Sets (SPS), PPS, current macroblock position, picture order count, current slice number, encoded bitstream, rate control mode parameters, neighboring motion vector for motion vector prediction, entropy encoding states such as Context Adaptive Variable Length Coding (CAVLC)/Context Adaptive Binary Arithmetic Coding (CABAC), multiple reference frames in decoded picture buffer, current reconstructed frame, and so on. For a H.263 decoder, data to be saved may include profile, level, bitstream position, current macroblock position, frame number, reference frame, current reconstructed frame, and so on. For a H.264 decoder, data to be saved can be SPS, PPS, current macroblock position, picture order count, current slice number, slice header, quantization parameter, neighboring motion vector for motion vector prediction, entropy coding states such as CAVLC/CABAC, multiple reference frames in decoded picture buffer, current reconstructed frame, and so on. To reduce the amount of data to save, an encoder can be forced to generate an IDR or intra-coded frame so that it will not require any past frames when it resumes. However, for a decoder, unless it knows that the next frame to decode is an IDR or intra-coded frame, it has to save all reference frames.

In various embodiments of the present invention, the aspects that are saved are different for different elements depending on factors both related to an element and also to how it is being employed in the pipeline. For example, a frame-scalar is stateless and so does not need to be preserved in all cases, other situations such as HTTP connections to sources cannot easily resume. An element may be in at least one of the following states: internally stateful (i.e. maintaining a state internally), being stateless (a scalar) and externally stateful (i.e. the state is dependent or shared with something external such as a remote TCP connection)

FIG. 10D illustrates a second client requesting the same data prior to disconnection of Receiver 1 1006 from the pipeline 1000, and receiving the cached version. As shown in the figure, Receiver 2 1010 receives a cached version of data requested at time N−1. In various embodiments of the present invention, since media data stored in Cache 1004 is dynamically requested by a plurality of clients in real time, Cache 1004 may not contain entire portion of a needed asset. The system of the invention may recognize the need to restore the processing pipeline 1000 prior to Cache 1004 being exhausted and to put the pipeline 1000 in order for a seamless transition between the cached media and the media produced from the restored processing pipeline.

FIGS. 10E and 10F illustrates restoration of state of pipeline 1000 and processing of the pipeline 1000 after state restoration. As shown in the figure, at time N, state of pipeline 1000 is restored through Storage 1008 and Cache 1004 is replenished from the point where the restoration is commenced. After restoration of the pipeline 1000, as shown in FIG. 10F, Receiver 2 1010 receives data from Cache 1004.

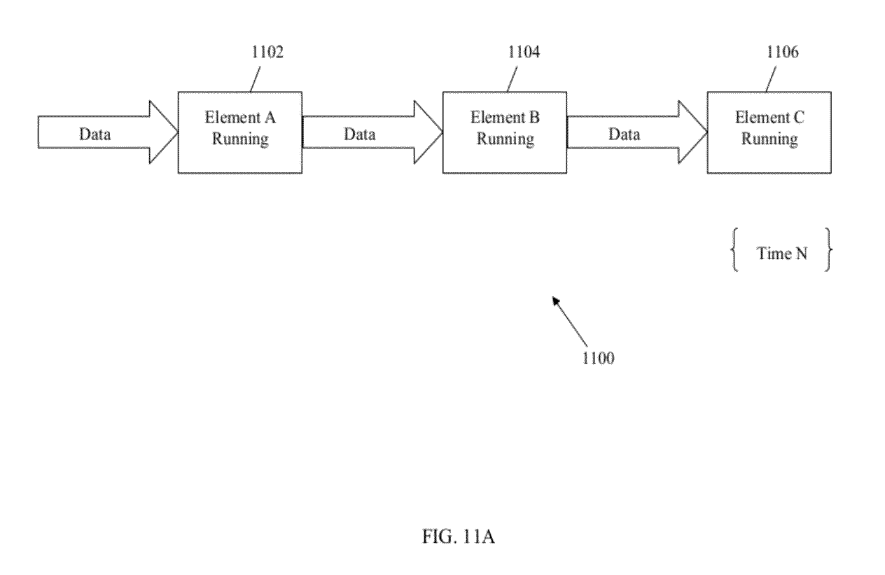

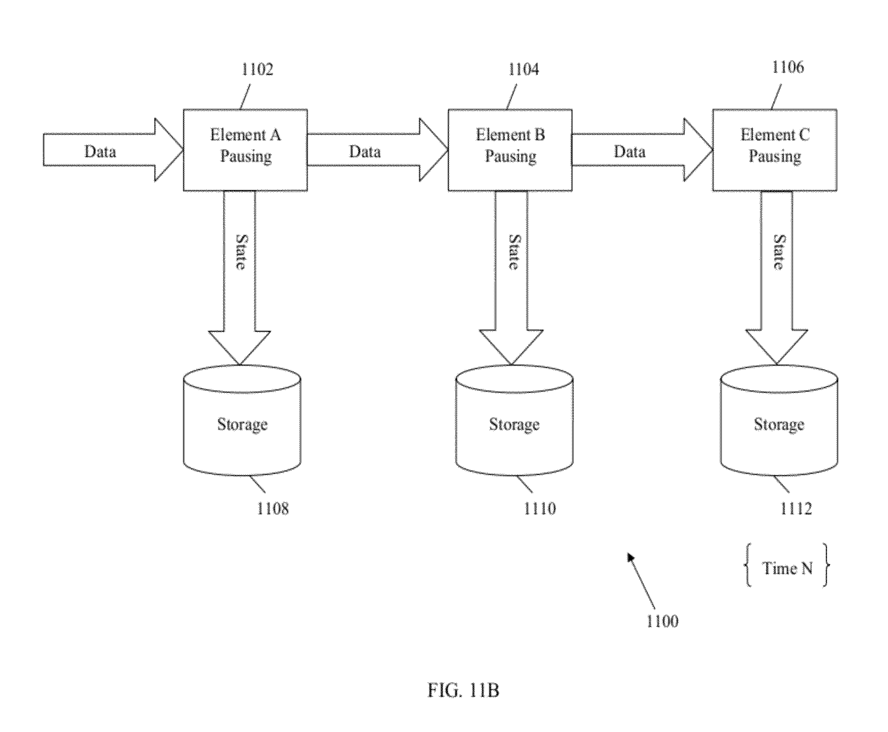

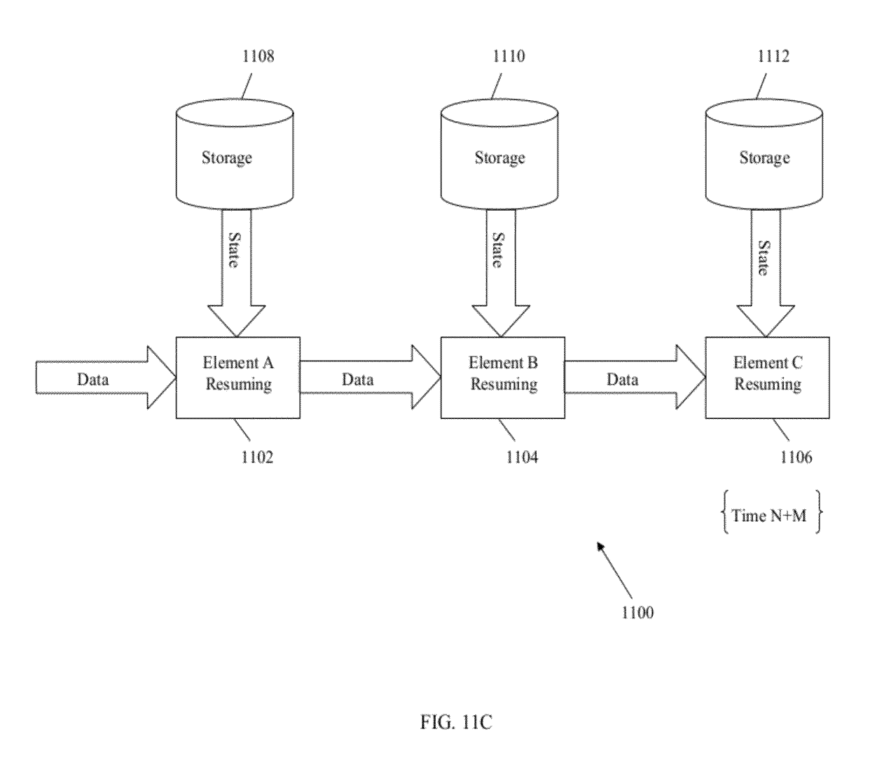

FIGS. 11A and 11B illustrates functioning of a media processing pipeline 1100 composed of a plurality of elements, in accordance with an embodiment of the present invention. As shown in FIG. 11A, Element 1102, Element 1104 and Element 1106 are engaged in the processing of media files at time N. FIG. 11B illustrates pausing of the pipeline 1100 which includes pausing of each Element 1102, Element 1104 and Element 1106 of the pipeline. Pausing of the pipeline 1100 includes saving states of the pipeline 1100 in Storage 1108, 1110 and 1112 respectively. FIG. 11C illustrates resumption of elements: Element 1102, Element 1104 and Element 1106 of the pipeline 1100 at time N+M. Whilst all elements may be saved, it is not necessary to save all elements and all facets of a pipeline. All internally stateful elements should be saved, or have enough information available that they can be resumed and that upstream elements can be resumed to provide the same state. Stateless elements need only be recorded as being present in the pipeline and externally stateful may need additional information stored in order to be saved.

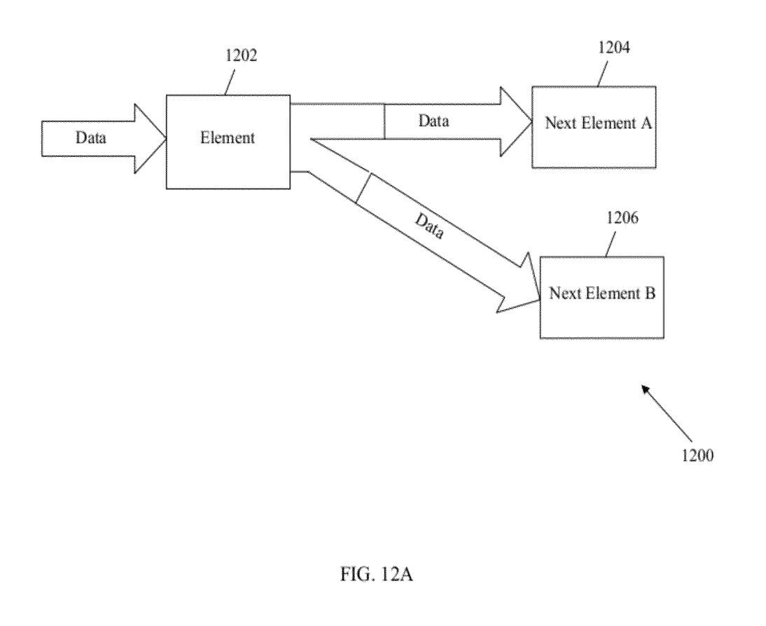

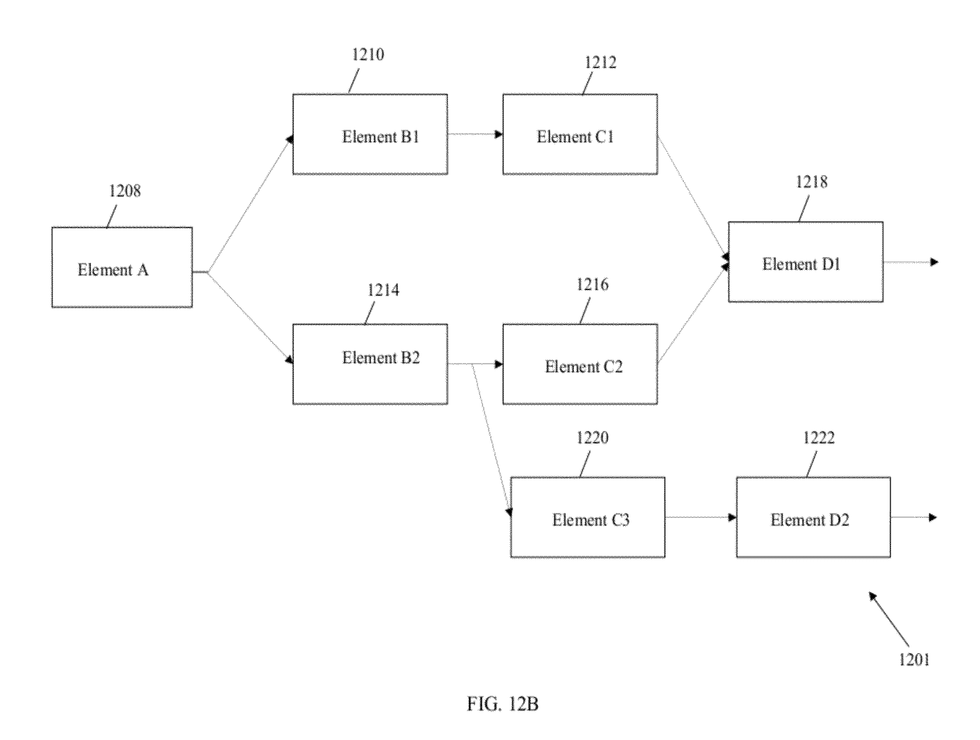

FIGS. 12A and 12B illustrate forking of one or more elements of a media processing pipeline. In an embodiment of the present invention, if there is high probability of a different aspect of processing being used and a low marginal cost relative to reproducing it, then the pipeline is augmented to provide for a pre-caching-by-side-effect. As an example, the present invention may provide for thumbnail extraction from a requested video processing thereby causing pre-caching of thumbnails for other purposes. FIG. 12A illustrates forking of Element 1202 in a processing pipeline 1200 such that the output of Element 1202 may be used in an additional pipeline elements Next Element A 1204 and Next Element B 1206. FIG. 12B illustrates forking of multiple elements in a processing pipeline. As shown in the figure, the elements: Element A 1208 and Element B2 1214 are forked to provide outputs to other elements within the pipeline.

In various embodiments of the present invention, certain requests for assets are not best suited for individual requests but external logic might require a particular calling style. If for example a framework can only handle a single asset at a time then the requesting logic will be item by item but for some cases the production of these assets is much more efficiently done in a batch or a continuous running of a pipeline. A concrete example is the case of thumbnails, or other image extractions for moderation, that may be wanted at various points in a video stream. For example an interface to a media pipeline, such as RequestStillImage(source clip, image_type, time_offset_secs) might be invoked to retrieve still images three times as follows:

RequestStillImage (clipA, thumbnail_PNG, 10)

RequestStillImage (clipA, thumbnail_PNG, 20)

RequestStillImage (clipA, thumbnail_PNG, 30)

An un-optimized solution might create three separate pipelines and process them separately even though they are heavily related and the case requesting 30 seconds is likely to traverse the other two cases, which may lead to substantial overheads.

An embodiment of the present invention forces a logic change on the caller and has all requests bundled together (E.g. RequestStillImages(clipA, thumbnail_PNG, [10, 20, 30])) so that the pipeline can be constructed appropriately. This exposes the implementation requiring the order of the frames to be provided to coincide with decoding of the clip sand is not always optimized. Another embodiment of the present invention provides a “latent” pipeline that remains extant between calls. Latent pipeline is provided on a threshold limit of linger time, or by making a determination (such as an heuristic, recognition of a train of requests or hard coded rule) or from a first request indicating that the following request will reuse the pipeline for a set number of calls or until a release is indicated. This kind of optimization may still be limited and only work if the requests are monotonically increasing. However, in an embodiment of the present invention, an extension where the content is either seekable or has seekability meta-information available is used which allows for (some forms) of random access. In another embodiment of the present invention, a variation of this is used in which the state is stored to disk or memory or and is restored if needed again, rather than keeping the pipeline around.

Yet another embodiment of the present invention minimizes the amount of state that needs to be saved and is applicable across many more differing invocation cases. Instead of saving the entire state at the end of each processing, there could be a separate track of meta-data that saves restoration points at various times in the processing. This separate track allows for quick restoration of state on subsequent requests, allowing for future random requests to be served efficiently. The following table shows these embodiments behavior to a train of requests:

| | | | Restoration points |
|---|---|---|---|
| Request | Basic pipeline | Latent pipeline | pipeline |
| Request(20) | Process from start until 20. | Process from start until 20. | Process from start until |
| | Tear down pipeline. | Leave pipeline extant for a | 20. Saving restore |
| | | threshold time. | information at 10 and 20. |
| Request(40) | Process from start until 40. | Re-use pipeline. Process | Process from 20 until 40. |
| | Tear down pipeline. | from 20 until 40. Leave | Saving restore |
| | | pipeline. | information at 30 and 40. |
| Request(60) | Process from start until 60. | Re-use pipeline. Process | Process from 40 until 60. |
| | Tear down pipeline. | from 40 until 60. Leave | Saving restore |
| | | pipeline. | information at 50 and 60. |
| Request(30) | Process from start until 30. | Can't re-use pipeline. | Process at 30. |
| | Tear down pipeline. | Process from start until 30. | |
| | | Leave pipeline. | |
| Request(29) | Process from start until 29. | Can't re-use pipeline. | Process from 20 until 29. |
| | Tear down pipeline. | Process from start until 29. | |
| | | Leave pipeline. | |

The asset saving mechanism described here is also applicable to other cases where multiple assets are being produced but only one can be saved at a given time. For example a request to retrieve a single media stream from a container format containing multiple streams can more efficiently produce both of them if a request is made that allows the processing to be done more efficiently or even in a joined fashion. An interface might be designed with some delay in the outputs, where permissible, so that all requests that might attach themselves to a particular pipeline can do so.

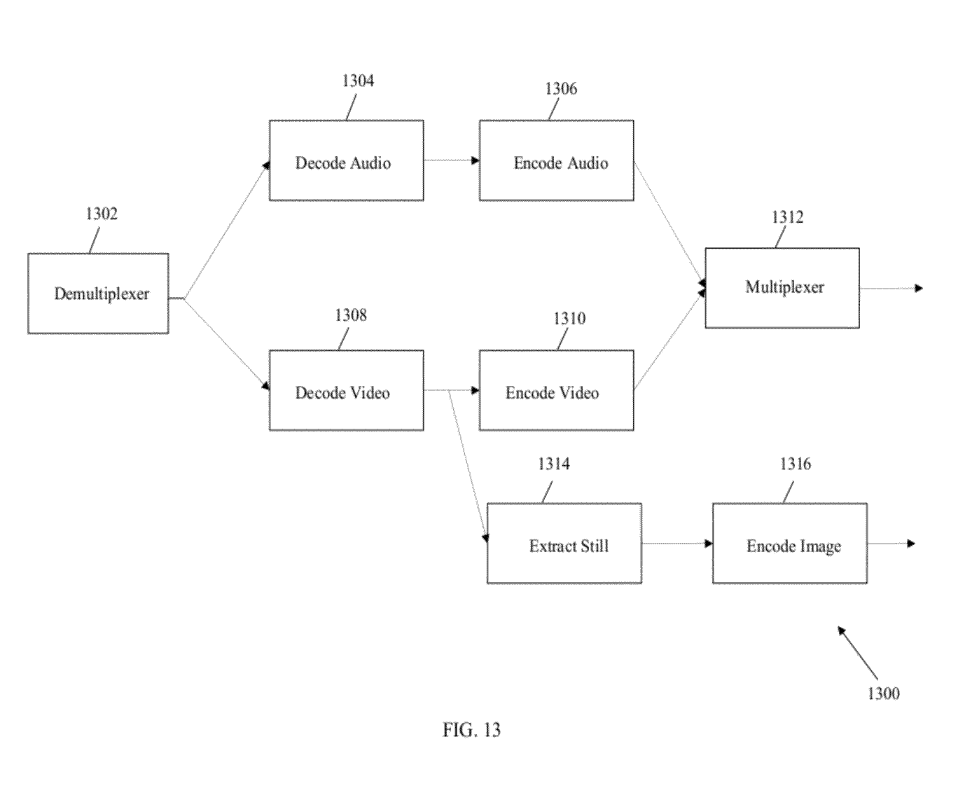

FIG. 13 illustrates forking of a pipeline 1300 to produce still images according to an embodiment of the invention. The figure illustrates forking of video information for still extraction whilst still processing the video for encoding as illustrated by steps 1308, 1310 and 1314. The output of the pipelines are multiplexed video 1312 and associated Encoded still image 1316 that may be used as thumbnails for static display, or miniature animated images (e.g. Flash or GIF), on a web page.

One of the embodiments of the present invention provides for optimal graph/pipeline creation. After the creation of a pipeline or graph representing the desired pipeline, a step occurs that takes into account characteristics of each element of the pipeline and optimizes the pipeline by removing unnecessary elements. For example if enough characteristics match between an encoder and a decoder the element is converted to a pass-through, copy-through, or minimal conversion. Transraters or optimized transcoders can also replace the tandem approach. The optimizer may decide to keep or drop an audio channel if it can optimize an aspect of the session (i.e. keep if can save processing, drop if it can help video quality in a constrained situation). Also, certain characteristics of the pipeline might be considered as soft requirements and may be changed in the pipeline if processing or quality advantage can be obtained. The optimization process takes into account constraints such as processing burden, output bandwidth limitations, output quality (for audio and video) to assist in the reduction algorithm. The optimization process can occur during creation, at the addition of each element, after the addition of a few elements, or as a post creation step.

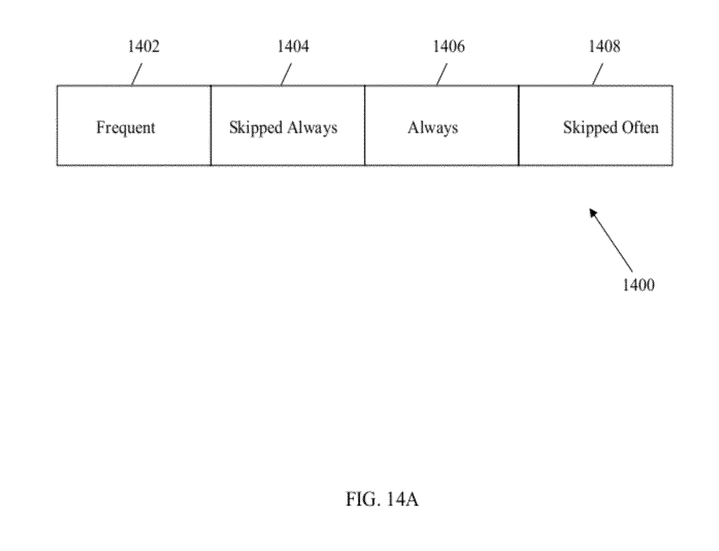

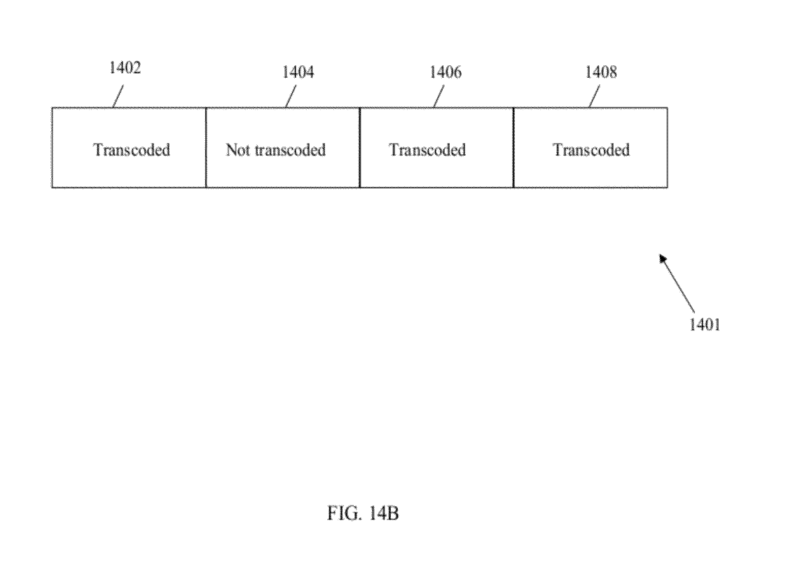

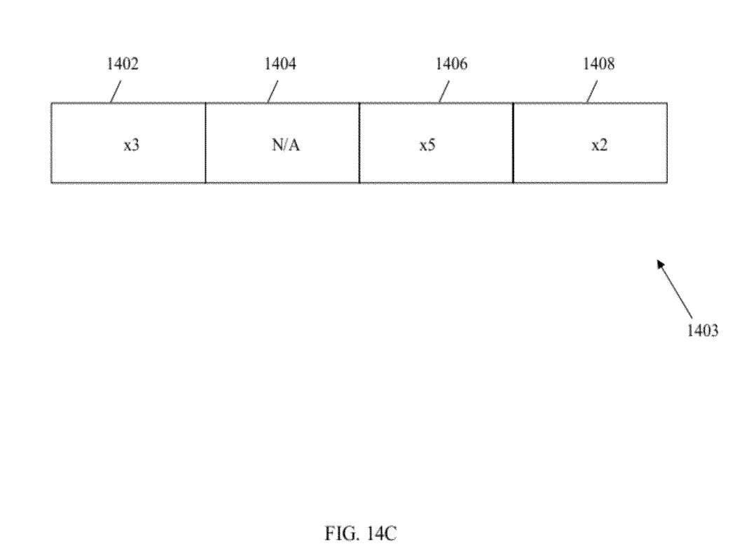

FIGS. 14A, 14B and 14C illustrate access requirements of requested media content and processing portions of the media content based on the access requirements. FIG. 14A illustrates access pattern for media content 1400 in accordance with an embodiment of the present invention. Media content 1400 may be a media clip, a time based piece of media or a frame based piece of media. Some parts of the clip are accessed more frequently than other parts. As shown in the figure, portion 1402 is frequently accessed, portion 1404 is always skipped, portion 1406 is always accessed and portion 1408 is often skipped. Embodiments of the present invention provide for differing treatment of different portions based on their request profile. FIG. 14B illustrates processing one or more portions of media content 1400 based on client access requirements. In various embodiments of the present invention, by executing element state storage and resumption (as disclosed in FIGS. 10B and 10C), the system and method of the present invention employs transcoding avoidance (a mode where only sections of media content which are requested by clients are transcoded (rather than the whole object). Portions 1402, 1406 and 1408 are transcoded since the aforementioned portions are accessed at least for some period of time. The requested transcoded sections may be stored as a series of segments and spliced together at delivery time, or spliced as a background task to reduce the quantity of stored objects and reduce delivery overhead. Further, in various embodiments of the present invention, transcoded portions are stored dynamically in cache memory. The availability of media content in cache memory changes based on access pattern of media content. If the pattern of access changes over time, the availability pattern in cache memory can resemble this access pattern so that memory cost can be saved.

FIG. 14C illustrates iterative processing of media content 1400 based on access requirements. Iterative processing of media includes iterative transcoding of processed media in order to achieve optimum refinement of media content as per access pattern. In an embodiment of the present invention, iterative transcoding includes applying more processing effort to achieve better quality, or use of assistance information to increase conformance to a bitrate profile, such as constant bitrate. In another embodiment of the present invention, iterative transcoding is used to increase the efficiency of the use of certain container types where padding might be used and iterative transcoding can provide a “better fit”. In yet another embodiment of the present invention, additional processing need not be limited to just the encoding of media content. Additional processing of media such as spatial scaling or temporal scaling of media may be applied with the use of advanced algorithms.

The following table illustrates processing of media content for improving quality of a media clip or segment on successive requests.

| Quality Improve- | | | Requested N + Mth |
|---|---|---|---|
| ment Logic | Requested 1^{st} time | Requested Nth time | time |
| Typical action | Process in real-time, | Process in real-time, using the | Process in real time, |
| | storing information for | stored information to increase | using all stored |
| | subsequent passes. | quality. Produce additional | information. |
| | Use a low complexity | information. | Use full complexity |
| | toolset | Use an intermediate | toolset. |
| | | complexity toolset. | |
| Action if system | Admit real-time session | Create a batch session to be | Create a batch session |
| under load | but use lower | run at a later time with settings | to be run at a later time |
| | quality/complexity | as above | with settings as above |
| | toolset | | |

As shown in FIG. 14C, media portions 1408, 1402 and 1406 are iteratively transcoded at increasing levels respectively corresponding to frequency of access patterns of the media portions.

In various embodiments of the present invention, Adapter 104 (illustrated in FIG. 1) has the ability to support media streams (either real time or delivered as HTTP files/objects). This is advantageous in order to reduce session setup time for playback of multiple clips, or to allow embedding of advertisements in order to provide a revenue stream for providing media services. Media content consumers are accustomed to having an ability to ‘seek’ different parts of media content, especially when the content is delivered using Progressive Download (PD) methods. Different parts of the media content are sought by moving a ‘progress bar’ in order to locate a later section of the video being played. For commercial reasons, when media content being supplied contains embedded media advertising elements or other ‘official’ notices it is beneficial if the consumer cannot easily skip past these items into the content itself.

For the purpose of fulfilling the objective of offering options for seeking media content, embodiments of the present invention provide for selective seeking of points within the media content when delivering the media content with advertisements embedded within the content. This facility is especially useful for spliced content and in particular when advertisements are spliced within media content. In order to provide for selective seeking of media content, Adapter 104 provides a scheme where content playlists delivered as Progressive download can have regions in which they are ‘seekable’ and controlled by a delivery server.

In various embodiments of the present invention, when the delivery of seekable playlist of content is requested, each item in the playlist, its duration and the seeking mode to be used for each clip can be defined. A resultant output ‘file’ generated by Adapter 104 has seek points defined in media container format header if all of the items defined in the playlist are already in its cache or readily accessible (and available for serving without further transcoding). If all the items defined in the playlist are not present in cache or are not readily accessible, then the system of the invention can define the first frame of the file as seekable. In various embodiments of the present invention, the seek points defined should correspond with each of the items in the clip according to the ‘seek mode’ defined for each.

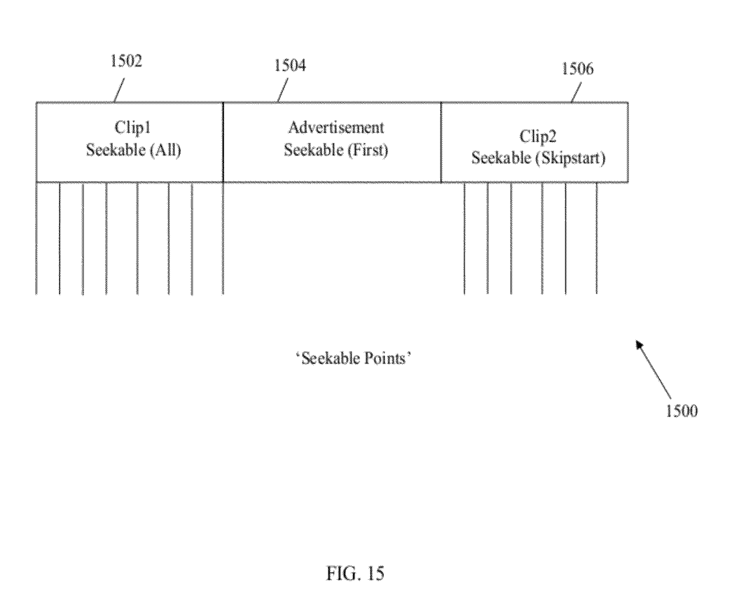

Media content 1500 illustrates an advertisement item 1504 spliced between two media content items 1502 and 1506. As shown in FIG. 15, seek mode for items 1502, 1504 and 1506 of media content 1500 are defined based on seekable points occurring within the items. In various embodiments of the present invention, seek mode options that are defined for the aforementioned items may include, but are not limited to, None, All, First and Skipstart. Characterizations of seek mode options are as follows:
1) None—No seek points are defined for media clip or item.
2) All—All the intra-coded frames in the media clip are marked as seekable points, including the first frame.
3) First—Only the first frame in each clip is marked as seekable (equivalent to ‘chapters’)
4) SkipStart—All of the intra-coded frames are marked as seekable points
   except for those in a defined initial period, N, for example in the first 10 seconds. This mode is especially useful for clips immediately following advertisements.

In various embodiments of the present invention, a media consumer would not be able to seek to start of the second clip 1506, but would instead be forced to either see the start of the advertisement 1504 or skip some portion on the beginning of the clip next to the advertisement 1504, and so in many cases would watch through the advertisement, but would retain the facility to seek back and forth within the content in order to maintain the capability already offered on many services. In an embodiment of the present invention, Adapter 104 has the ability to resolve byte range requests to media items defined in the playlist, and identify the location within each clip to deliver content from.

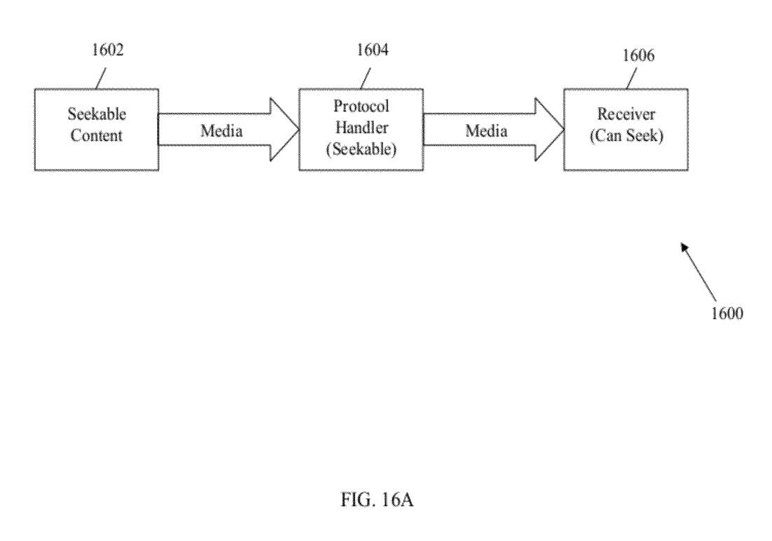

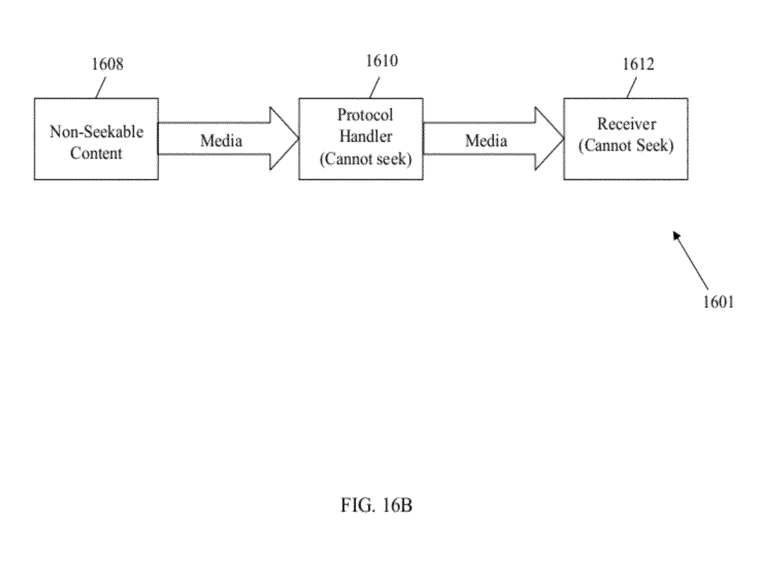

FIG. 16A illustrates a receiver seeking seekable content according to an embodiment of the invention. The figure shows seekable media content being seeked through Protocol Handler 1604 and Receiver 1606 which have seekable capability. An example of this may be when the media content is a progressively downloadable static file, Protocol Handler 1604 is an HTTP server compliant to HTTP 1.1 and Receiver 1606 is capable of byte range requests (and media decoding as appropriate).

FIG. 16B illustrates a case where Receiver 1612 has seeking capability but is unable to seek media content because certain points in the media are not seekable, i.e. Content 1608 is non-seekable. Media content may not be directly seekable due to either limitations of the content itself or the container. However, in cases where the source content has had some limited pre-processing, seeking may be possible. In some cases ‘soft-seeking’ may be allowable where the seek point is determined by limited search within the source media for a suitable play point.

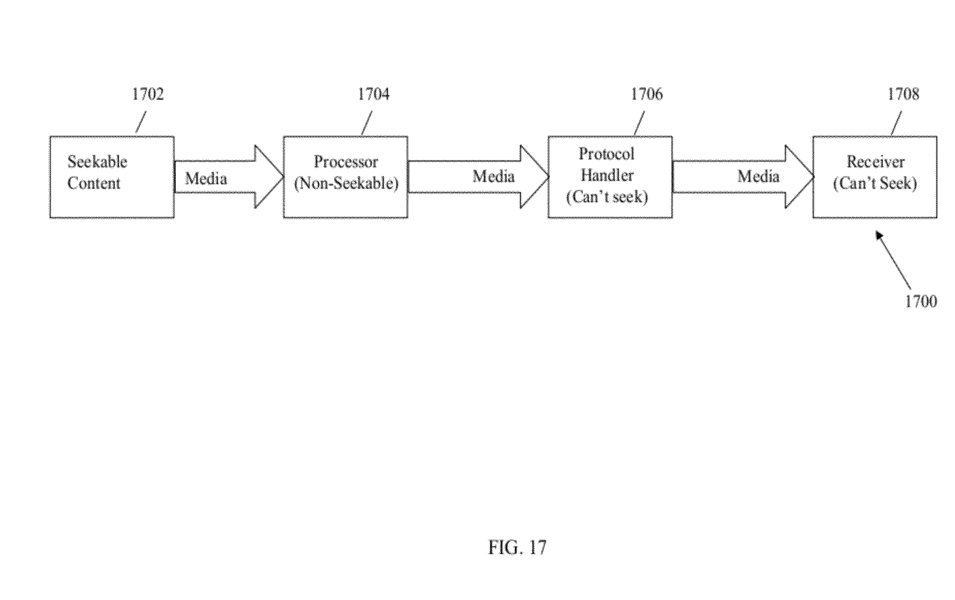

Non-seekable sessions are also produced when seekable content is available but the protocol handler or the clients are not capable of seeking FIG. 17 illustrates issues with media processing solutions where the source content is seekable but limitations in one or more aspects of the processing prevents seeking from occurring. As shown in the figure, Content 1702 is seekable but Processor 1704 is not configured to maintain seekability in the media content. In an exemplary embodiment of the present invention, media pipeline 1700 consists of a decoder and an encoder. The decoder cannot randomly access a particular section of the source file and continue decoding from that point. In another exemplary embodiment of the present invention, the decoder is capable of producing media content but encoder is not able to randomly access the bitstream.

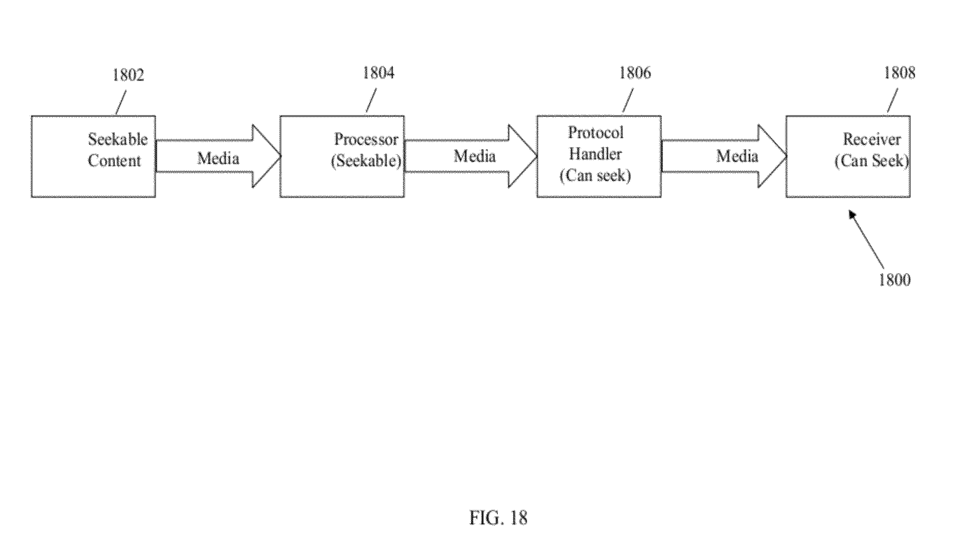

FIG. 18 illustrates establishing seekability during processing of media content, in accordance with an embodiment of the present invention. In various embodiments of the present invention, in the case of audio and video content, seekability may be established only at frame boundaries. By adding decoder refresh points, seekability can be established efficiently. For establishing seekability in a video decoder, a certain amount of “total stream” information might be necessary allowing random points to be accessed. One or more elements of Processor 1804 are configured so that seekability in any incoming seekable content is maintained.

In various embodiments of the present invention, for allowing seekability at the output of an encoder within Processor 1804, a discontinuous jump to a new location in the output could be made and at a seekable point, or a point near to it according to an optimization strategy. Further, a decoder refresh (intra-frame, IDR, etc) point can be encoded. The encoder is then configured so that if a seek to the same point occurs, the same data is always presented.

In an embodiment of the present invention, when a seek action to a point occurs, the encoder should be signaled by the application or framework driving the encoder. After receiving the signal, an encoder can save all state information that can allow resumption of encoding. The states to be saved can be quantization parameter, bitstream, current frame position, current macroblock position, rate control model parameter, reference frame, reconstructed frame, and so on. In an embodiment of the present invention, the saving of the states is immediate. In another embodiment of the present invention, an encoder continues processing at a rate faster than real-time, until all frames are received before the frame that is seeked to. After receiving the signal and before encoding the seeked-to frame, an encoder can produce some transition frames to give better perceptual quality and keep the client session alive. After receiving the data of the frame that is seeked-to, an encoder can encode an intra-frame or IDR frame, so that Receiver 1808 can decode it without any past data. All saved states can be picked up by another encoder if there is another seeking to the previously stopped location. An alternative embodiment spawns a new encoder for each seeked request that is discontinuous, at least beyond a threshold that precludes processing the intermediate media. The existing encoder is either parked and the state is stored. The state is stored either immediately or after a certain feature is observed or a time limit reached. In an embodiment of the present invention, the encoder continues to transcode, possibly at a reduced priority, until the point of the new encoder is reached. A new encoder starts providing media at the new “seeked-to” location and begins with decoder refresh point information.

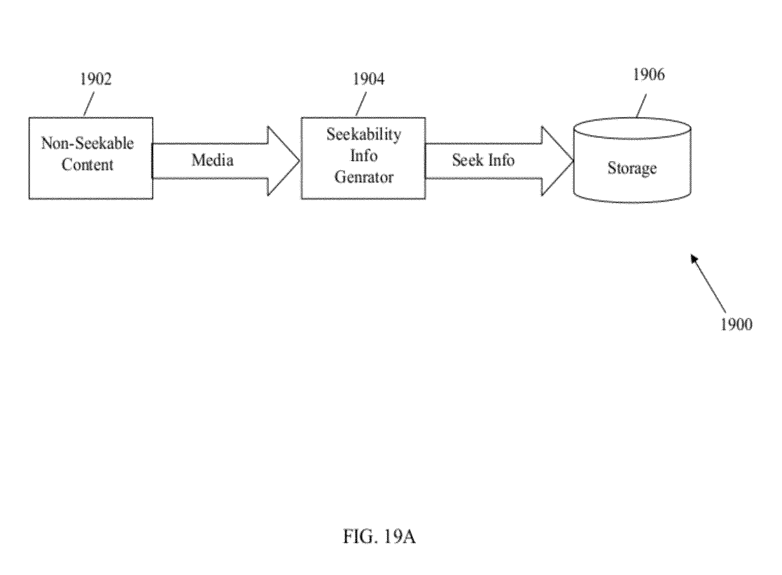

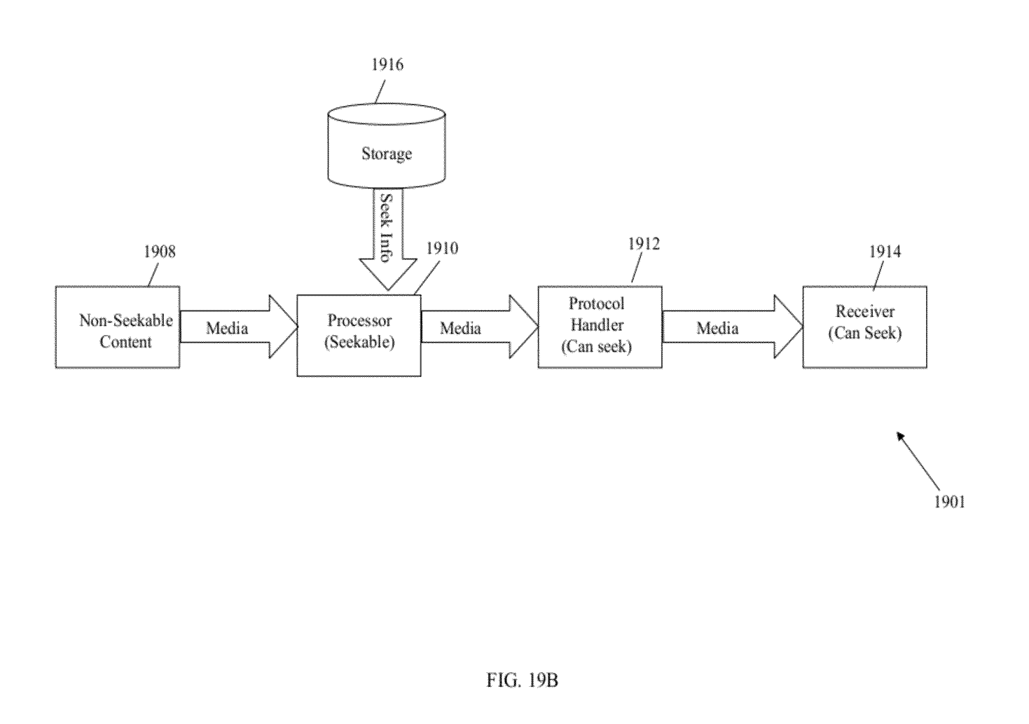

For content that is not inherently seekable, such as freeform/interleave containers without an index, it is possible to produce seekability information from a first processing of the bitstream. This information is shown as being produced in FIG. 19A. The information could take a few forms, it might be an index generated from the file, such as byte offsets or time offsets of frames. Such information is not only limited to seekability but is usable with the other uses of meta-information disclosed in the present application. Examples of uses of meta-information include saving an index for simple restoring of state or production of thumbnails.

FIG. 19B illustrates use of additional information, augmenting non-seekable content to create seekable output from the processing element. Seekability “injected” in this way at Processor 1910, for example using meta-data indices, can be inherited along the pipeline. As the seekability of an element cannot always be easily identified, embodiments of the present invention use an indication that can be propagated along the pipeline, which can be achieved in a number of ways such as element to element exchange, negotiation or discovery or by a top level element that represents a container for the entire pipeline that can inspect each element and determine if the entire chain is seekable.

When accessing a media streaming service, one or more terminals can make use of a media bitstream provided at different bitrates. The usage of the varied bitrates can be due to many factors such as variation in network conditions, congestions, network coverage, and etc. Many devices like smartphones switch automatically from one bitrate to another, when a range of media bitrates are made available to them.

In a conventional video streaming session, a video bitrate is usually set prior to the session. Depending on the rate control algorithm, the video bitrate may vary in a short time but the long term average is approximately the same throughout the entire streaming session. If the channel data rate increases during the session, the video quality cannot be improved as the bitrate is fixed. If the channel data rate decreases, high video bitrate could cause a buffer overflow, video jitter, delay and many other video quality problems. In order to provide a better user experience, some streaming protocols, such as Apple HTTP streaming, 3GPP adaptive HTTP streaming, and Microsoft Smooth Streaming, offer the ability to adaptively and dynamically adapt the video bitrate according to the variations in the channel data rate in an open-loop mode. An example of open-loop mode includes a player on the user's device detecting video bitrate change needs). In some other streaming protocols such as 3GPP adaptive RTSP streaming, adaptation is achieved in a closed-loop mode: The user's device sends the reception conditions to the transmitting server which adjusts the transmitted video bitrate accordingly.

In the open-loop bitrate adaptation mode, the streaming media can be prepared at each bitrate using recovery points, such as intra-coded frames, IDR, SP/SI slices. A simple example is a set of separate media chunk files instead of a continuous media file. There can be multiple sets of media chunk files for multiple bitrates. Every media chunk is a self-contained media file that is decodable without any past or future media chunks. The media chunk file can be in MPEG-2 TS format, 3GP fragment box, or MP4 fragment box. The attributes of the streaming media, such as media chunk duration, total media duration, media type, bitrate tag associated with media chunks and media URL, can be described in a separate manifest file. A streaming client first downloads a manifest file from a streaming server at the beginning of a streaming session. The manifest file indicates to the client all available bitrate options to be downloaded. The client can then determine which bitrate to select based on current data rate and then download the media chunks of that bitrate. During the session, the client can actively detect the streaming data rate and switch to download media chunks at different bitrates listed in the manifest corresponding to the data rate changes. The bitrate adaptation works in the open-loop mode because the streaming server does not receive any feedback from the client and the decision is made by the client.

In the closed-loop bitrate adaptation mode, the streaming media can be sent from a streaming server to a client in a continuous stream. During the session, the streaming server may receive some feedbacks or requests from the client to adapt to streaming bitrate. In an embodiment of the present invention, the bitrate adaptation could work from a server's perspective in that it can shift the bitrate higher or lower depending on the user's device receive conditions.

Regardless of whether the streaming protocol is in the open- or the closed-loop mode, it can be desirable to produce all bitrates at the server at all times, especially in a large-scale streaming service where many clients can access the same media at different bitrates. To encode multiple output bitrates, one approach can be to have an encoder farm that consists of multiple encoders that each has its own interface and runs as an independent encoding entity. One challenge with this approach is its high computational cost. Encoding is a computationally intensive process. If the computation cost for an encoder to encode (or transcode) a video content to one bitrate is C, the total computation cost for an encoder farm to encode the same content to N different bitrates is approximately C times N, because every encoder in the encoder farms runs independently. In fact, if two or more encoders are encoding the same video content, many operations can be in common for all encoders. If repeating those common operations can be avoided, and saving in computational cost for every output bitrate is S, the total saving for N output bitrates can be S times N, which could lead to a significant reduction in computation resources and hardware expense.

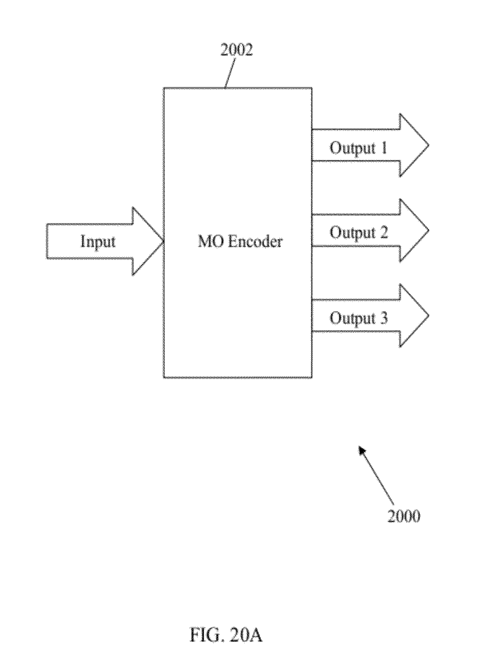

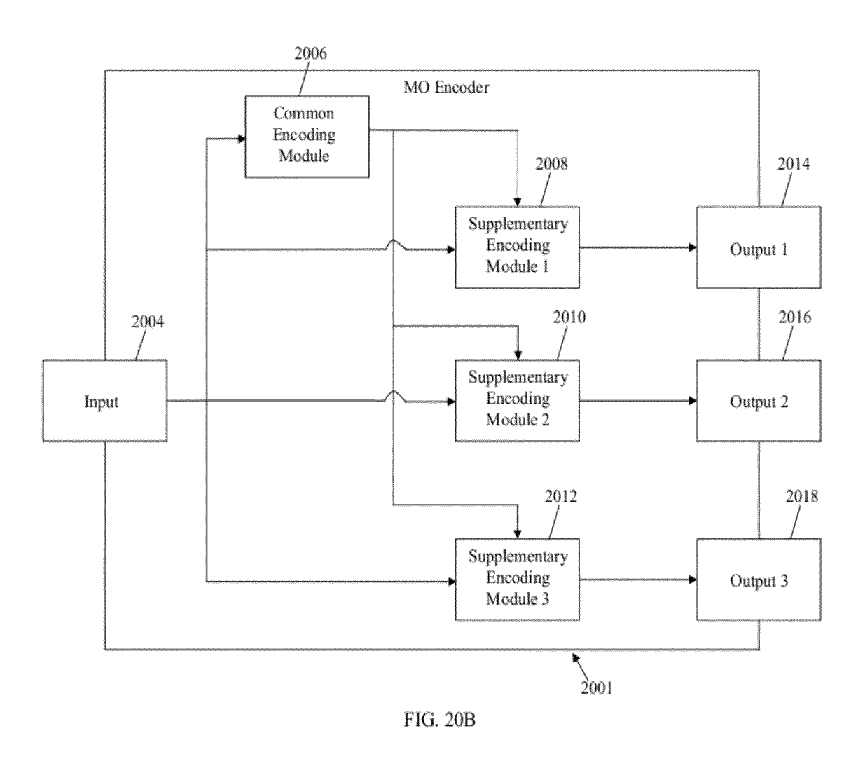

In an embodiment of the present invention, the system and method of the invention provides a Multiple Output (MO) encoder. FIG. 20A illustrates high level architecture of the MO encoder 2002 which can take an input and produce multiple outputs. An example of the outputs produced could be multiple differing bitrates, or differing profiles. It can take one input and produce multiple outputs. An example of outputs produced could be multiple differing bitrates, or differing profiles. MO encoder 2002 can offer a general encoding structure and many optimization techniques that can be deployed for all video encoding formats such as H.263, MPEG-4, H.264, VC-1, VP8 and many more. FIG. 20B illustrates general internal structure of the MO encoder 2002 that consists of an input module, a common encoding module, multiple supplementary encoding modules and multiple output modules. The common encoding module can process all common encoding operations for all outputs. And the supplementary encoding module can process encoding operations for each specific output. The common encoding module can provide media data to the supplementary encoding module. The media data can be completely coded macroblocks, slices, frames, or it can be partially coded data with encoder assistance information. An input module, a common encoding module, a supplementary encoding module and an output encoding module can comprise a standalone encoder for a specific output. MO encoder 2002 can be a multi-tap encoder that the first tap is a standalone encoder and every other tap consists of a supplementary encoding module and an output module. Every tap can produce a different output. The outputs can be different in bitrate, entropy coding format, profile, level, codec type, frame rate, frame size and etc.

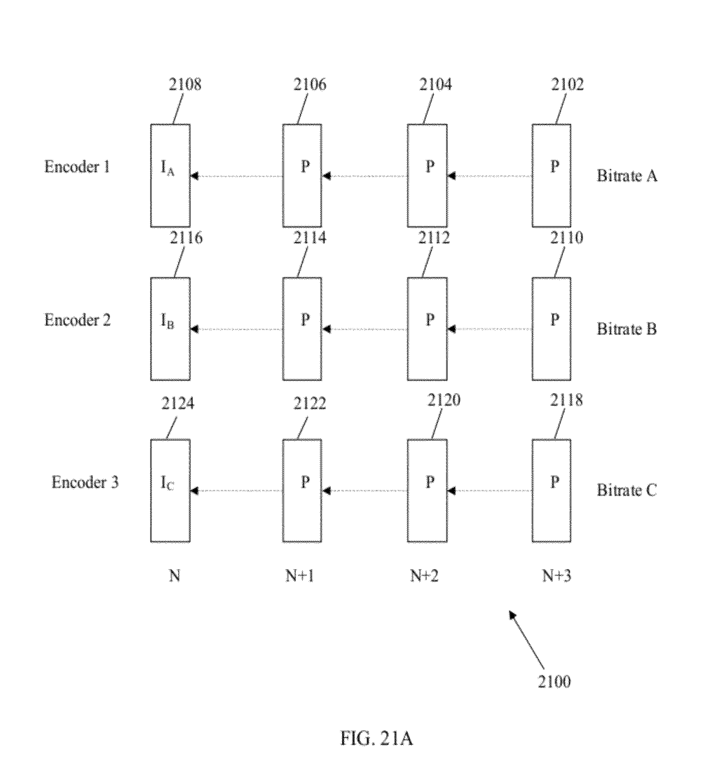

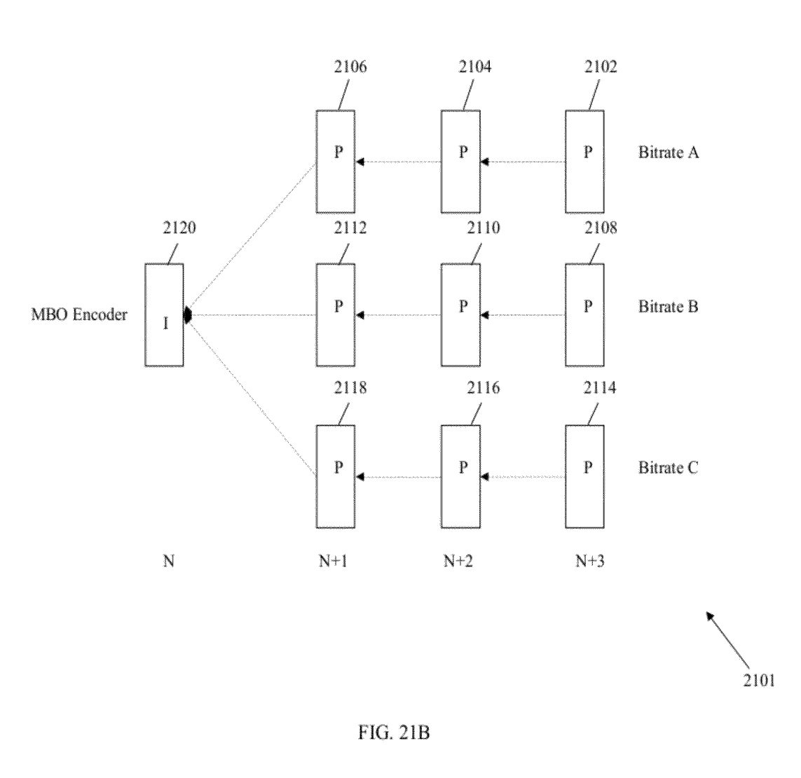

In another embodiment of the present invention, means are provided to efficiently encode IDR or intra-frame in the MBO encoder for several bitrate outputs. FIG. 21A illustrates how three independent encoders can encode the frame N to I frames for output bitrates A, B, and C. The rate control modules in the encoders can determine frame bit count targets to encode this frame for bitrate A, B, and C and further determine different Quantization Parameters (QPs) to encode the frame. The reconstructed frames: I_{A}, I_{B}, and I_{C} are then used as reference frames for encoding subsequent predictive frames. In video encoding, an intra-frame serves as a refresh point where the encoding and decoding of this frame is independent to any previous or future frames. Therefore, any of these three reconstructed frames can be used to replace any other two reconstructed frames as reference frames to encode subsequent predictive frames without introducing any drifting error. That is to say that I_{A} can replace I_{B} or I_{C}; or I_{B} can replace I_{A} or I_{C}, and vice versa. FIG. 21B illustrates how the MBO encoder 2120 can encode the frame N to an I-frame for output bitrate A, B, and C efficiently. Instead of encoding three I frames, only one frame is encoded as a common intra-frame for three bitrates. The generated bitstream data can be directly used for all output bitrates, and the other encoding results, including the reconstructed frame and many encoder internal states, can also be used for encoding subsequent predictive frames of all output bitrates.

In video encoding, the quality of an intra-frame can be heavily affected by the frame bit target that is normally determined by the rate control. In addition, the quality of an intra-frame can have a big impact on the subsequent predictive frames, because the intra-frame is used as the reference frame. The frame bit target of a common intra-frame is directly related to the quality of all output bitrates. A rate control algorithm normally can keep the average bitrate in a window of frames to be close to the target bitrate. If encoding a common intra-frame consumes much more bits than the original bitrate, the rate control can assign fewer bits to the subsequent predictive frames to meet the target bitrate, but this can lead to a quality drop in the predictive frames. If encoding a common intra-frame consumes much lesser bits than the original bitrate, the quality of the common intra-frame can be low, which can have negative impact on the subsequent predictive frames too, as the reference frame has low quality. For a common intra-frame that can achieve good video quality for two or more output bitrates, the fluctuation of the frame bit target of the common intra-frame around every original frame bit target in percentage should be within a certain range. Typically, the fluctuation can be in the range of −20%˜20%.

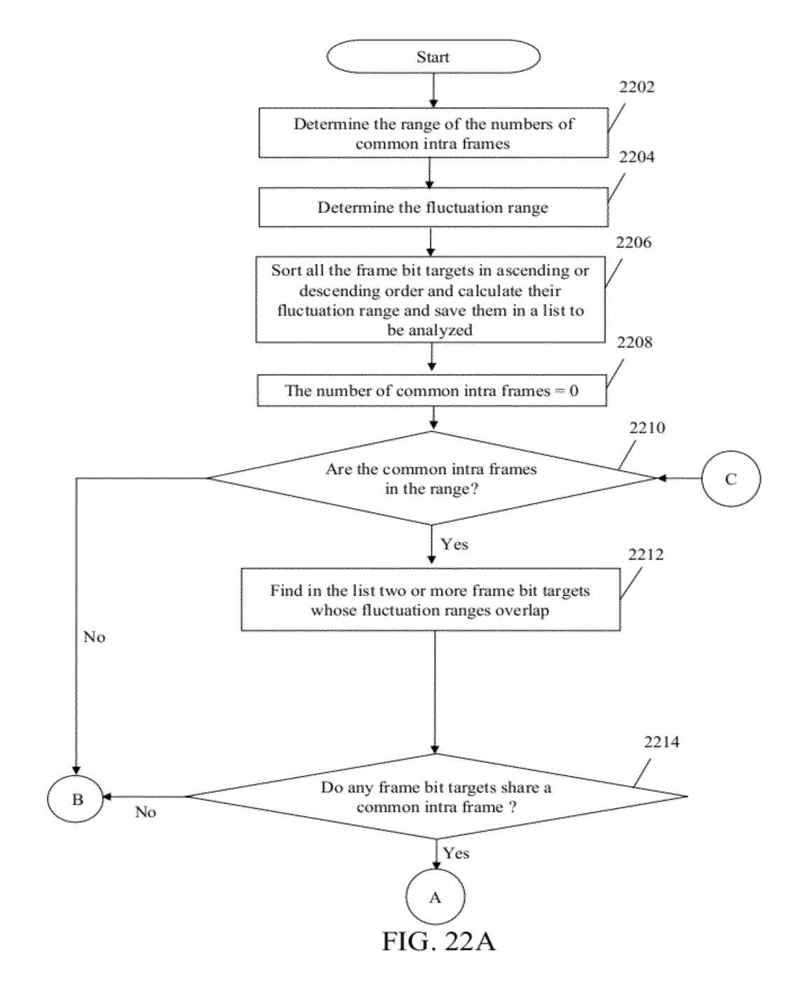

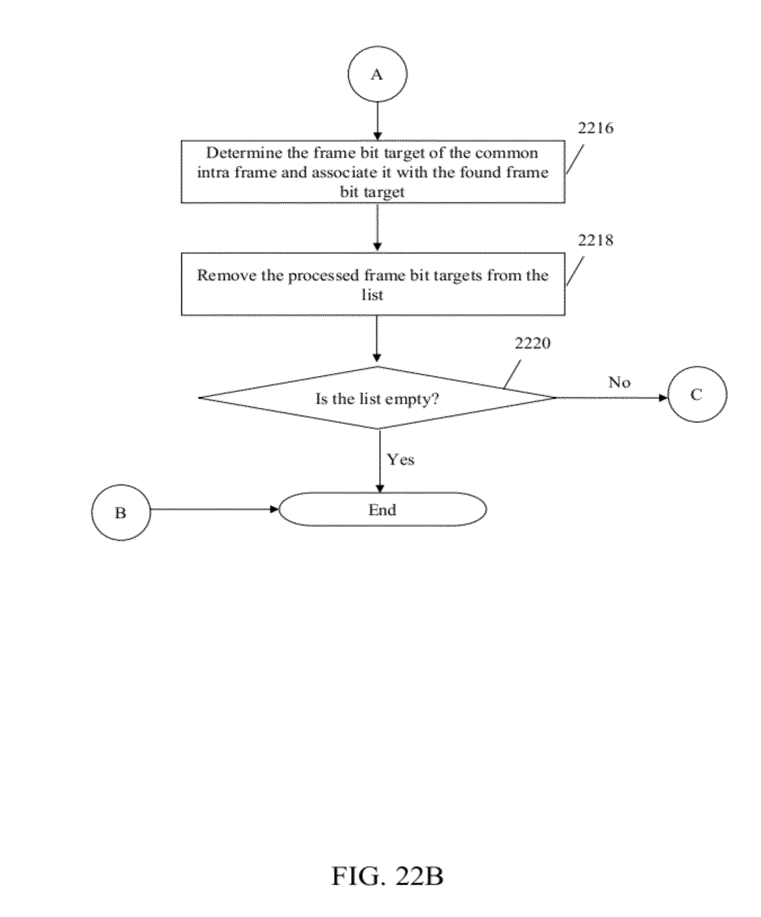

FIGS. 22A-22B illustrate a flowchart to determine common intra-frames for all the output bitrates of the MBO encoder. At step 2202, range of the number of the common intra-frames is determined according to quality requirement, performance requirement or other policies. In various embodiments of the present invention, the lower limit of the range can be zero, which suggests that there is no common intra-frame. The upper limit of the range can be equal to floor (the number of output bitrates/2), because a common intra-frame is shared by at least two bitrates. After the determination of range of number of common intra-frames, at step 2204, fluctuation range can be determined also based on quality requirement, performance requirement or other policies. Then, at step 2206, all original frame bit targets can be sorted in ascending or descending order. A fluctuation range that is from X % lower to X % higher than an original frame bit target can be formed for every frame bit target and all fluctuation ranges can be saved in a list in the same order of the original frame bit targets. Any frame bit target in a fluctuation range can be used to encode a good quality common intra-frame. Thereafter, at step 2208, number of common intra-frames which are in zero range are determined.

At step 2210 it is determined whether the common intra-frames are within range. If it is determined that the common intra-frames are not within range, the process flow stops. However, if it is determined that the common intra-frames are within range, at step 2212, two or more frame bit targets whose fluctuation range overlap are determined. Firstly, all fluctuation ranges in the list are examined. If it is determined that two or more fluctuation ranges are overlapping, then at step 2214 it is determined whether any frame bit targets share a common intra-frame. If two or more fluctuation ranges overlap, one common intra-frame can be encoded with a frame bit target in the overlapped range, for the original frame bit targets that are associated with these fluctuation ranges. The frame bit target of a common intra-frame can be equal to any of values in the overlapped range, or it can be the average or median of the values in the overlapped range.

If it is determined that frame bit targets share a common intra-frame, at step 2216, frame bit target of the common intra-frame is determined and associated with the frame bit target. The processed frame bit targets are then removed from the list at step 2218. The same process can continue until either the list is empty or the number of total common intra-frames is out of the allowed range. The common intra-frames, their frame bit targets, and the associated original bitrates can be saved for the main intra-frame encoding process of the MBO encoder. If it is determined at step 2220 that the list is empty, the process flow proceeds to step 2210.

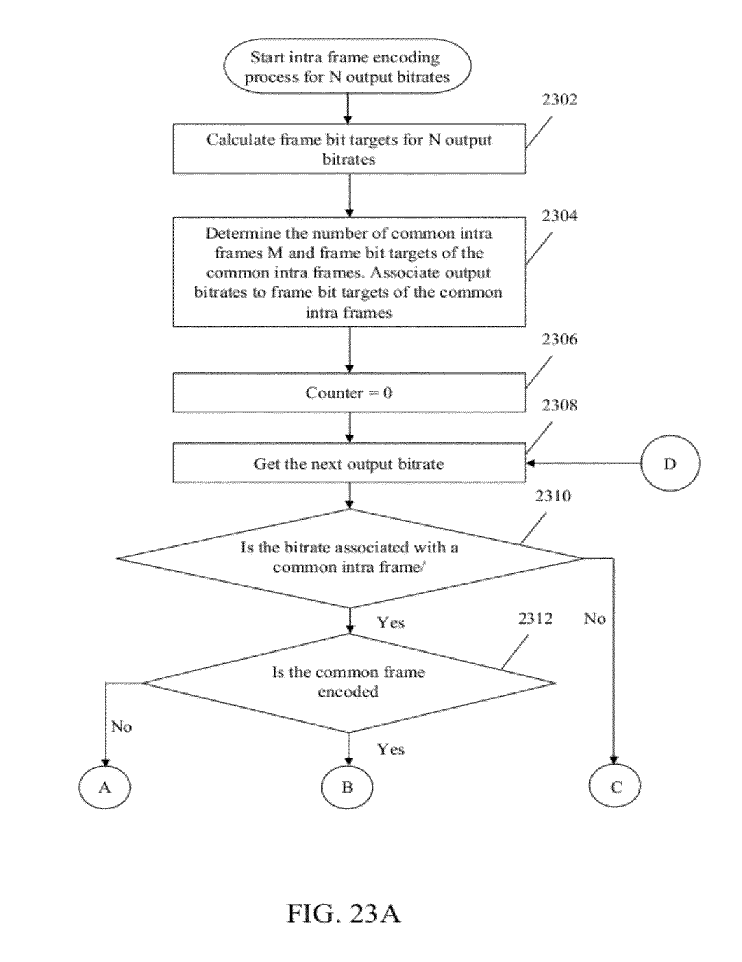

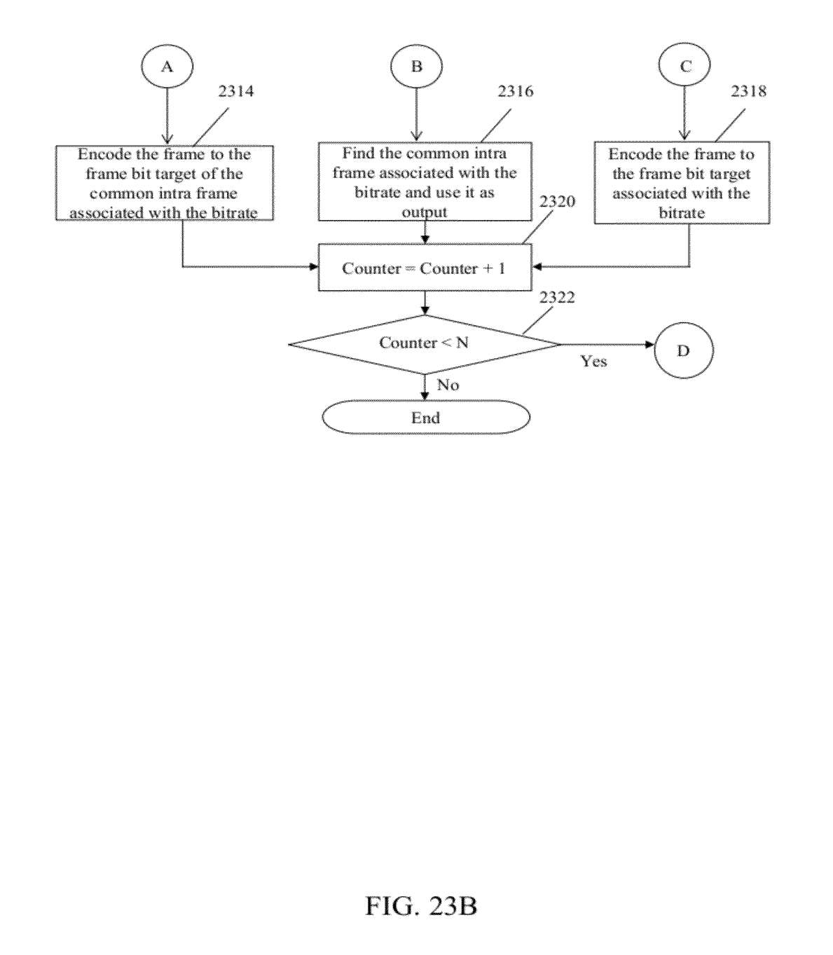

FIGS. 23A-23B illustrate a flowchart that illustrates efficient encoding of IDR or intra-frames in the MBO encoder for several bitrate outputs. At step 2302, the MBO encoder calculates all frame bit count targets of all output bitrates. Based on frame bit targets, at step 2304 the number of common intra-frames that can be encoded for all the output bitrates, the frame bit targets for all the common intra-frames, and the associations of the output bitrate to the frame bit targets of all common intra-frames are determined. Thereafter, at step 2306 the MBO encoder starts the main encoding loop for all the output bitrate. At step 2308 an output bitrate to be encoded is obtained. At step 2310 it is checked whether the bitrate is associated with any common intra-frames or not. If the bitrate is not associated with any common intra-frames, the MBO encoder encodes the frame to the frame bit target that is associated with the original bitrate at step 2318. If it is determined that the bitrate is associated with a common intra-frame, at step 2312 the MBO encoder checks if the common intra-frame is encoded or not. If the common intra-frame is already encoded, at step 2316, the MBO encoder uses the encoded common intra-frame as the output. Otherwise, the MBO encoder can encode the common intra-frame to the frame bit target associated with it and also save the state that this particular common intra-frame is encoded. The encoding loop continues until there is either a common intra-frame or a standard intra-frame encoded for every output bitrate. The encoding loop continues until there is either a common intra-frame or a standard intra-frame encoded for every output bitrate.

If the common intra-frame is not encoded, at step 2314, the MBO encoder encodes the common intra-frame to the frame bit target associated with it and also saves the state that this particular common intra-frame is encoded. The encoding loop continues until there is either a common intra-frame or a standard intra-frame encoded for every output bitrate.

According to an embodiment of the present invention, in the MBO encoder, Discrete Cosine Transform (DCT) coefficients of one intra macroblock encoded for one output bitrate may be directly used for encoding the same intra macroblock for other output bitrates, because in many video coding standards, such as H.263, MPEG-4 and others, the DCT coefficients are calculated from the original frame data that is the same for all output bitrates. In another embodiment of the invention, the MBO encoder encodes common intra macroblock, common intra GOB, and common intra slice for different output bitrates. In yet another embodiment of the present invention, in the MBO encoder, the intra prediction mode of one intra macroblock encoded for one output bitrate may be directly used for encoding the same intra macroblock for other output bitrates, because the intra prediction modes are determined based on the original frame data that is the same for all output bitrates.

An embodiment of the present invention provides encode predictive frames in the MBO encoder. Unlike for an intra-frame, predictive frame encoding cannot be shared by multiple output bitrates directly, but it can be optimized by using encoder assistance information. The assistance information can be macroblock modes, prediction sub-modes, motion vectors, reference indexes, quantization parameters, number of bits to encode, and so on as described more through the present application. After finishing encoding one inter frame for one output bitrate, the MBO encoder can use the assistance information to optimize the operations such as macroblock mode decision, motion estimation for the other output bitrates.

Another embodiment of the present invention provides a technique that the MBO encoder can use the encoder assistance information to optimize the performance of macroblock mode decision. It can directly reuse macroblock modes for one output bitrate in encoding of other output bitrates, because the mode of a macroblock can be closely related to the video characteristic of the current raw macroblock which is the same for all output bitrates. For example, if a macroblock was encoded as inter 16×16 mode for one output bitrate, this macroblock can most likely contain less details that require finer block-size. So, it can be encoded in inter 16×16 mode for other output bitrates. To further improve the video quality, the MBO encoder can do a fast mode decision that only analyzes macroblock modes around it. The determination of whether to perform direct reuse or further processing can be made depending on factors such as similarities of QP, bitrates and other settings.

Yet another embodiment of the present invention provides a technique that the MBO encoder uses assistance information to optimize the performance of motion estimation. It can directly reuse prediction modes, motion vectors and reference indexes from encoding one bitrate in encoding another bitrate for fast encoding speed. Or it can use them as good starting points and do fast motion estimations in limited ranges. The determination of direct reusing or further processing can be made depending on factors such as similarities of QP, output bitrates, and other settings.

Yet another embodiment of the present invention provides a H.264 MO encoder. A common encoding module of the H.264 MO encoder can perform common encoding operations such as inter/intra macroblock mode decision, inter macroblock motion estimation, scene change detection and all operations for common intra macroblocks, slices and frames including integer transform and inverse transform, intra prediction, quantization and de-quantization, reconstruction, entropy encoding, de-blocking and so on. Every supplementary encoding module of the output can perform operations specific to its output. Operations specific to its output may include operations such as decoding picture buffer management, motion composition. Further, the operations include operations for non-common intra and inter macroblocks, operations for slices and frames such as integer transform and inverse transform, intra prediction, quantization and de-quantization, reconstruction, entropy encoding, de-blocking and so on.

Yet another embodiment of the present invention provides a VP8 MO encoder. A common encoding module of the VP8 MO encoder can perform common encoding operations such as inter/intra macroblock mode decision, inter macroblock motion estimation, scene change detection and all operations for common intra macroblocks, slices and frames including integer transform and inverse transform, intra prediction, quantization and de-quantization, reconstruction, Boolean entropy encoding, loop filtering and so on. Every supplementary encoding module of the output can performs operations specific for its output such as decoding picture buffer management, motion compensation, and operations for non-common intra and inter macroblocks, slices and frames including integer transform and inverse transform, intra prediction, quantization and de-quantization, reconstruction, Boolean entropy encoding, loop filtering and so on.

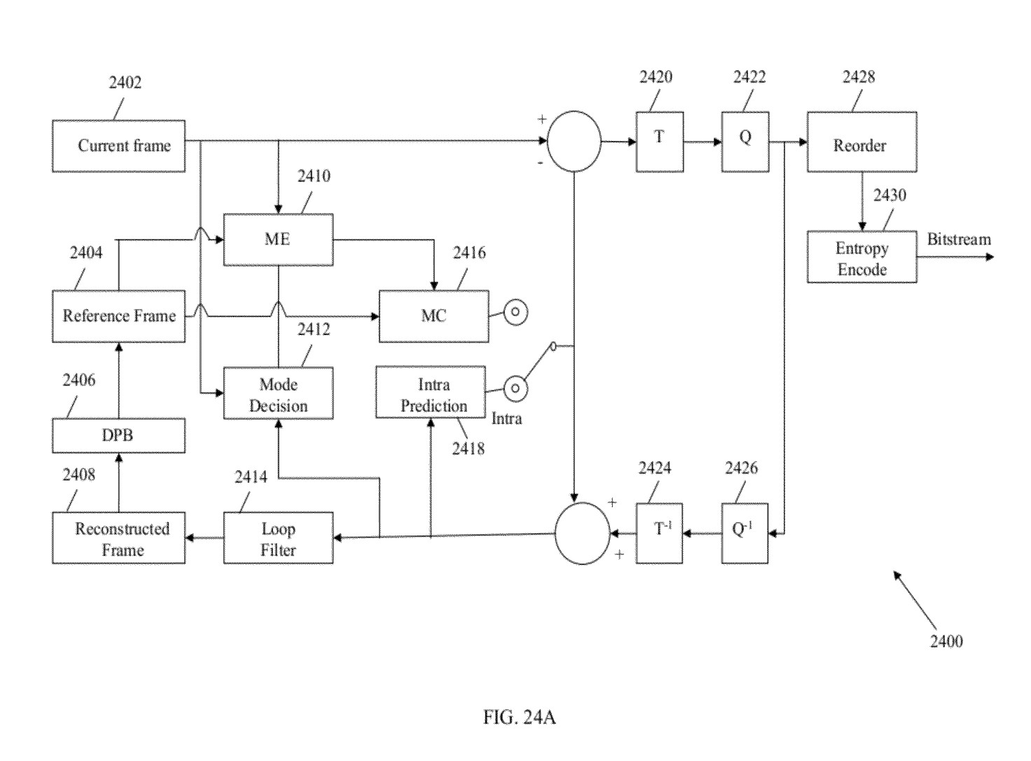

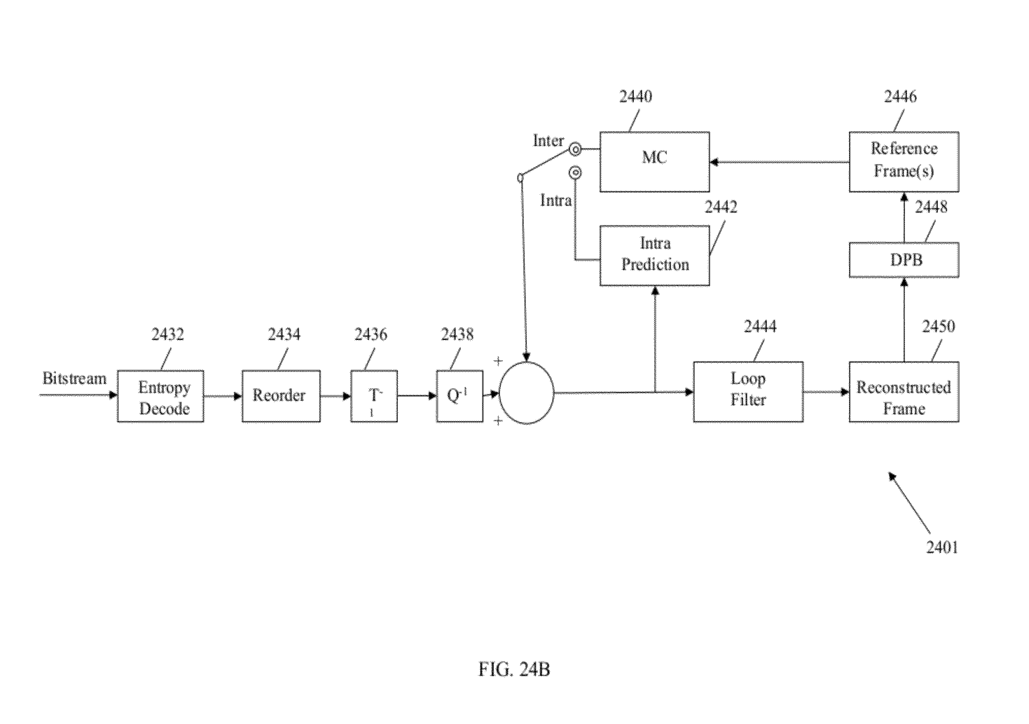

FIG. 24A illustrates a common high-level structure of the H.264 encoder and the VP8 encoder. H.264/AVC/MPEG-4 Part 10 is a video coding standard developed jointly by the ITU-T Video Coding Experts Group (VCEG) and the ISO/IEC Moving Picture Experts Group (MPEG). The H.264 video format provides many profiles and levels that can be used in a broad range of applications such as video telephony (e.g. SIP, 3G-324M), internet streaming, Blu-Ray disc, VoD, HDTV broadcast, Digital Video Broadcasting (DVB) broadcast, Digital Cinema, video conferencing, video surveillance, and etc. Many technologies that are used in the H.264 are patented, so vendors and commercial users of products that use H.264/AVC are required to pay patent royalties. The VP8 codec, primarily targeted for internet video, can be supported by many internet browsers and many media players.

Transcoding between H.264 and VP8 means converting video format from one to another without changing video bitrate. The transrating is transcoding with changing video bitrate. One straight forward approach for transcoding is so-called tandem approach that does full decoding and full encoding, which is very inefficient. In an embodiment of the present invention, smart transcoding is done by utilizing decoding side information such as macroblock modes, QPs, motion vectors, reference indexes and etc. This smart transcoding can be done in either direction, H.264 to VP8 or VP8 to H.264. The fast encoding requires conversion of the side information between VP8 and H.264. The conversion can be direct mapping or intelligent conversion. When bitrate is not major, there is a high similarity between VP8 and H.264, and the side information (incoming bitstream information) can often be directly used. For example, when transcoding from VP8 to H.24, all prediction modes that are in VP8 are in H.264, so the prediction modes in VP8 can be directly mapped to corresponding H.264 prediction modes. For mapping a prediction mode only in H.264 but not in VP8, the mode can be converted intelligently to the closest mode in VP8. Also, decoded prediction modes can also be used for some fast mode decision process in the encoder. Motion vectors in VP8 and H.264 are both quarter-pixel precision so they can be directly converted from one to another with consideration of the motion vector range limited by profile and levels. Also, motion vectors can be used as an initial point of further motion estimation or motion refinement. H.264 support more reference frames than VP8, so the mapping of a reference index from VP8 to H.264 can be direct while mapping a reference index from H.264 to VP8 need to check if the reference index is in the range that VP8 supports. If it is out of range, motion estimation needs to be performed for motion vectors associated with this reference index. This approach still requires full decoding and encoding of DCT coefficients. One another approach can be to also transcode DCT coefficients at a frequency domain since two video formats use a very similar transform scheme. A relationship between H.264 transform and VP8 transform can be derived since they both are based on DCT and can use the same block size. The entropy decoded DCT coefficients of a macroblock can be scaled, converted using the derived relationship and re-quantized to the encoding format.

Transrating between H.264 and VP8 means converting video format from one to another with changing video bitrate. The approach described in the transcoding that utilizes side information to speed up encoding can also be used except that the side information becomes less accurate due to bitrate change. When using the side information, the encoder can use some fast encoding algorithms such as fast mode decision, fast motion estimation and so on to improve the performance of transrating. The various embodiments can be provided in a multimedia framework that uses processing elements provided from a number of sources. It is applicable to XDAIS, GStreamer, and Microsoft DirectShow.

Encoder 2400 processes a raw input video frame in units of a macroblock that contains 16×16 luma samples. Each macroblock is encoded in intra or inter mode. In intra mode, the encoder performs a mode decision to decide intra prediction modes of all blocks in a macroblock and a prediction is formed from neighboring macroblocks that have previously encoded, decoded and reconstructed in the current slice/frame. In inter mode, the encoder performs Mode decision 2412 and Motion Estimation 2410 to decide inter prediction modes, reference indexes, and motion vectors of all blocks in the macroblock, and a prediction is formed by motion compensation from reference picture(s). The reference pictures are from a selection of past or future pictures (in display order) that have already been encoded, reconstructed and filtered stored in a decoded picture buffer. The prediction macroblock is subtracted from the current macroblock to produce a residual block that is transformed and quantized to give a set of quantized transform coefficients. The quantized transform coefficients are reordered and entropy encoded, together with side information required to decode each block within the macroblock and to create the compressed bitstream. The side information includes information such as prediction modes, Quantization Parameter (QP), Motion Vectors (MV), reference indexes and etc. The quantized and transformed coefficients of a macroblock are de-quantized and inverse transformed to re-produce a prediction macroblock. The prediction macroblock is added to the residual macroblock to create an unfiltered reconstructed macroblock. A set of unfiltered reconstructed macroblock is filtered by a de-blocking filter and a reconstructed reference picture is created after all macroblocks in the frame are filtered. The reconstructed frames are stored in the decoded picture buffer for providing reference frame. Both of the H.264 and the VP8 specifications define only the syntax of an encoded video bitstream and the method of decoding the bitstream. The H.264 decoder and the VP8 decoder have a very similar high-level structure.

FIG. 24B illustrates a common high-level structure of the H.264 and VP8 decoder. Decoder 2401 entropy decodes a compressed bitstream to produce a set of quantized coefficients, macroblock modes, QP, motion vectors and other header information. The coefficients are re-ordered, de-quantized and inverse transformed to give a decoded residual frame. Using the header information decoded from the bitstream, the decoder performs Intra prediction 2442 for intra macroblocks and motion compensation for inter macroblocks to create a prediction frame. The prediction frame is added to the residual frame to create an unfiltered reconstructed frame which is filtered to create a reconstructed frame 2450. Reconstructed frame 2450 is stored in a decoded picture buffer for providing reference frame.

In various embodiments of the present invention, for entropy coding, H.264 decoder uses fixed and variable length binary codes to code bitstream syntax above the slice layer and uses either context-adaptive variable length coding (CAVLC) or context-adaptive arithmetic coding (CABAC) to code bitstream syntax at the slice layer or below depending on the entropy encoding mode. On the other hand, the entire VP8 bitstream syntax is encoded using a Boolean coder which is a non-adaptive coder. Therefore, the bitstream syntax of VP8 is different from the one of H.264.

In various embodiments of the present invention, for transform, H.264 decoder and VP8 decoder uses a similar scheme. That is the residual data of each macroblock is divided into 16 4×4 blocks for luma and 8 4×4 blocks for chroma. All 4×4 blocks are transformed by a bit-exact 4×4 DCT approximation. And all DC coefficients of all 4×4 blocks are gathered to form a 4×4 luma DC block and a 2×2 chroma DC block, which are respectively Hadamard transformed. However, there are still a few differences between H.264 scheme and VP8's. A primary difference is the 4×4 DCT transform. H.264 decoder uses a simplified DCT which is an integer DCT whose core part can be implemented using only additions and shifts. VP8 decoder uses a very accurate version of DCT that uses a large number of multiplies. Another difference is that VP8 decoder does not use 8×8 transform. Yet another difference is that VP8 decoder applies the Hadamard transform for some inter prediction mode, and not merely for intra 16×16 in H.264.

In various embodiments of the present invention, for quantization, H.264 and VP8 basically follows the same process, but there are also many differences. Firstly, H.264's QP range is different from the VP8's. Secondly, H.264 can support frame-level quantization and macroblock-level quantization. VP8 primarily uses frame-level quantization and can achieve macroblock-level quantization using “Segmentation Map” inefficiently.

H.264 and VP8 have very similar intra prediction. Samples in a macroblock or block are predicted from the neighboring samples in the frame/slice that have been encoded, decoded, and reconstructed, but have not been filtered. In H.264 and VP8, different intra prediction modes are defined for 4×4 luma blocks, 16×16 luma macroblocks, and 8×8 chroma blocks. For a 4×4 luma block, in H.264, the prediction modes are vertical, horizontal, DC, diagonal-down left, vertical-right, horizontal-down, vertical-left, and horizontal-up. In VP8, the prediction modes for a 4×4 luma block are B_DC_PRED, B_TM_PRED, B_VE_PRED, B_HE_PRED, B_LD_PRED, B_RD_PRED, B_VR_PRED, B_VL_PRED, B_HD_PRED, and B_HU_PRED. Although H.264 and VP8 use different names for those prediction modes, they are practically the same. Likewise, for a 16×16 luma macroblock, the prediction modes are vertical, horizontal, DC, and Plane in H.264 and in VP8, the similar prediction modes are V_PRED, H_PRED, DC_PRED, and TM_PRED. For an 8×8 chroma block, the prediction modes are vertical, horizontal, DC, and Plane in H.264. Similarly, for an 8×8 chroma macroblock in VP8, the prediction modes are V_PRED, H_PRED, DC_PRED, and TM_PRED.

H.264 and VP8 both use an inter prediction model that predicts samples in a macroblock or block by referring to one or more previously encoded frames using block-based motion estimation and compensation. In H.264 and VP8, many of the key factors of inter prediction such as prediction partition, motion vector, and reference frame are much alike. Firstly, VP8 and H.264 both support variable-size partitions. VP8 can support partition types: 16×16, 16×8, 8×16, 8×8, and 4×4. H.264 can support partition types: 16×16, 16×8, 8×16, 8×8, 8×4, 4×8, and 4×4. Secondly, VP8 and H.264 both support quarter-pixel motion vectors. One difference is that H.264 uses a staged 6-tap luma and bilinear chroma interpolation filter while VP8 uses an unstaged 6-tap luma and mixed 4/6-tap chroma interpolation filter, and VP8 also supports the use of a single stage 2-tap sub-pixel filter. One other difference is that in VP8 each 4×4 chroma block uses the average of collocated luma MVs while in H.264 chroma uses luma MVs directly. Thirdly, VP8 and H.264 both support multiple reference frames. VP8 supports up to 3 reference frames and H.264 supports up to 16 reference frames. H.264 also supports B-frames and weighted prediction but VP8 does not.

H.264 and VP8 both use a loop filter, also known as de-blocking filter. The loop filter is used to filter an encoded or decoded frame in order to reduce blockiness in DCT-based video format. As the loop filter's output is used for future prediction, it has to be done identically in both the encoder and decoder, otherwise drifting errors could occur. There are a few differences between H.264's loop filter and VP8's. Firstly, in VP8's loop filter, there are two modes: a fast mode and a normal mode. The fast mode is simpler than H.264's, while the normal mode is more complex. Secondly, VP8's filter has wider range than H.264's when filtering macroblocks edges. VP8 also supports a method of implicit segmentation where it is possible to select different loop filter strengths for different parts of the image, according to the prediction modes or reference frames used to encode each macroblock. Because of its high compression efficiency, H.264 has been widely used in many applications. A large volume of contents have been encoded and stored using H.264. Many H.264 software and hardware codecs, H.264 capable mobile phones, H.264 set top boxes and other H.264 devices are implemented and shipped. For H.264 terminals/players to access VP8 content or for VP8 terminals/players to access H.264 content, or for communication between H.264 and VP8 terminals/players, transcoding/transrating between H.264 and VP8 are essential.

Embodiments of the present invention provide many advantages. These advantages are provided by methods and apparatuses that can adapt media for delivery in multiple formats of media content to terminals over a range of networks and network conditions, and with various differing services with their particular service logic. The present invention provides a reduction in rate by modifying media characteristics that can include as examples frame sizes, frame rates, protocols, bit-rate encoding profiles (e.g. constant bit-rate, variable bit-rate) coding tools, bitrates, special encoding, such as forward error correction (FEC), and the like. Further, the present invention provides better use of network resources allowing delaying or avoidance of replacement or additional network infrastructure equipment and user equipments. Further, the present invention allows a richer set of media sources to be accessed by terminals without requiring additional processing and storage burden of maintaining multiple formats of each content asset. A critical advantage of the invention includes shaping network traffic and effectively controlling network congestion. Yet another advantage is to provide differentiated services to allow for premium customers to receive premium media quality. Another advantage is to allow content to be played back more quickly on the terminal as the amount of required buffering is reduced. Another advantage is to improve user experience by adaptively adapting and optimizing media quality dynamically. A yet further advantage provides for increased cache utilization for source content that cannot be identified as identical due to differences in the way the content is served. Further advantages that are achieved are gains in performance, session density, whilst not restricting the modes of operation of the system. The gains can be seen in a range of applications including transcoding, transrating, transsizing (scaling) and when modifying media through operations such as Spatial Scaling, Cropping and Padding, and the conversion for differing codecs on input and differing codecs on output. Yet further advantages may include saving processing cost, for example in computation and bandwidth, reduce transmission costs, increasing media quality, providing an ability to deliver content to more devices, enhancing a user's experience through quality of media and interactivity with media, increasing the ability to monetize content, increasing storage effectiveness/efficiency and reducing latency for content delivery. In addition a reduction in operating costs and a reduction in capital expenditure is gained by the use of these embodiments.

Throughout the present application examples and embodiments the terms storage and cache have been used to indicate saving of information. These are not meant to be limiting, but instead may take on various forms, and may be simply structures in memory, or structures saved to disk, or swapped out of active memory or an external system or various other means of saving information.

Additionally, it is also understood that the examples and embodiments described herein are for illustrative purposes only and that various modifications or changes in light thereof will be suggested to persons skilled in the art and are to be included within the spirit and purview of this application and scope of the appended claims.

1.-16. (canceled)

17. A method of processing media, the method comprising:
receiving a first request for a media stream;
creating a media processing element;
processing a source media stream using the media processing element to produce a media stream and assistance information;
storing the assistance information;
receiving a second request for the media stream;
reprocessing the source media stream using a media reprocessing element to produce a refined media stream, wherein the media reprocessing element utilizes the assistance information.

18. The method of claim 17 wherein reprocessing the source media comprises a second pass encoding.

19.-28. (canceled)

29. An apparatus for processing media, the apparatus comprising:
a media source element;
a first media processing element coupled to the media source element;
a second media processing element coupled to a media output element;
a first data bus coupled to the first media processing element and the second media processing element; and
a second data bus coupled to the first media processing element and the second media processing element.

30. The apparatus of claim 29 wherein the first data bus transmits media data and the second data bus transmits media meta-information.

31. The apparatus of claim 29 wherein the second data bus transmits encoder assistance information.

32. The apparatus of claim 29 wherein the first media processing element is a decoder and the second media processing element is an encoder.

33. The apparatus of claim 29 wherein the first media processing element is an encoder and the second media processing element is an encoder.

34. The apparatus of claim 29 further comprising a third media processing element coupled to the first data bus and the second data bus.

35. The apparatus of claim 34 wherein the third media processing element converts a media frame arriving on the first data bus and converts assistance information arriving on the second data bus.

36. The apparatus of claim 34 wherein the first data bus and the second data bus are a same bus.

37. A method of processing media, the method comprising:
creating a first media processing element;
creating a second media processing element;
processing a first media stream using the first media processing element to produce assistance information;
processing a second media stream using the second media processing element,
wherein the second media processing element utilizes the assistance information.

38. The method of claim 37 wherein the first media processing element is a decoder and the second media processor is an encoder.

39. The method of claim 37 wherein the first media processing element is a first encoder and the second media processor is a second encoder.

40. The method of claim 37 further comprising processing a third media stream using a third media processing element, wherein the third media processing element utilizes the assistance information.

41. The method of claim 37 wherein processing a second media stream further comprises producing a second assistance information.

42. The method of claim 41 further comprising processing a third media stream using a third media processing element, wherein the third media processing element utilizes the second assistance information.

43. The method of claim 37 further comprising storing the assistance information.

44. The method of claim 37 further comprising processing the assistance information.

45. The method of claim 44 wherein processing the assistance information comprises combining one or more frames of assistance information.

46. The method of claim 44 wherein processing the assistance information comprises reducing a frame size.

47. The method of claim 44 wherein processing the assistance information comprises converting assistance information suitable for a first codec associated with the first media processing element to assistance information suitable for a second codec associated with a second media processing element.

48.-87. (canceled)
